(19) United States
(12) Patent Application Publication
(10) Pub. No.: US 2025/0039708 A1
(43) Pub. Date: Jan. 30, 2025

(54) Performing Measurements According to Relaxed Criteria

(71) Applicant: Telefonaktiebolaget LM Ericsson (PUBL), Stockholm (SE)

(72) Inventors: Santhan Thangarasa, VÄLLINGBY (SE); Muhammad Ali Kazmi, SUNDBYBERG (SE); Zhixun TANG, Beijing (CN); Chunhui Zhang, STOCKHOLM (SE)

(21) Appl. No.: 18/713,014

(22) PCT Filed: Nov. 24, 2022
(86) PCT No.: PCT/EP2022/083102

§ 371 Date: May 23, 2024

(30) Foreign Application Priority Data
Nov. 29, 2021 (WO) PCT/CN2021/134139

(51) Int. Cl. H04W 24/08; H04W 74/0808

(52) U.S. Cl. CPC H04W 24/08; H04W 74/0808

(57) ABSTRACT

Methods and apparatuses for control of measurements are disclosed. According to an embodiment, a terminal device obtains (202) information about at least one relaxed measurement criterion, RMC. The terminal device determines (204) whether first criteria associated with a first mode of operation, MO, or second criteria associated with a second MO are satisfied, based at least on the obtained information. Measurements under the first MO are less stringent than measurements under the second MO. At least one criterion in at least one of the first criteria and the second criteria is associated with a result of clear channel assessment, CCA, procedure in at least one cell. The terminal device uses (206) a result of the determination for performing one or more operational tasks.

### TECHNICAL FIELD

Embodiments of the disclosure generally relate to communication, and, more particularly, to methods and apparatuses for control of measurements.

### BACKGROUND

This section introduces aspects that may facilitate better understanding of the present disclosure. Accordingly, the statements of this section are to be read in this light and are not to be understood as admissions about what is in the prior art or what is not in the prior art.

The 5th generation (5G) is the fifth generation of cellular technology and was introduced in Release 15 of the 3rd generation partnership project (3GPP) standard. It is designed to increase speed, reduce latency, and improve flexibility of wireless services.

The 5G system (5GS) includes both a new radio access network (RAN) called next generation RAN (NG-RAN) which makes use of a new air interface called new radio (NR), and a new core network called 5G core network (5GC).

The initial release of 5G in Release 15 is optimized for mobile broadband (MBB) and ultra-reliable and low latency communication (URLLC). These services require very high data rates and/or low latency and therefore put high requirements on the user equipment (UE). To enable 5G to be used for other services with more relaxed performance requirements, a new low complexity UE type is introduced in Release 17, called ‘reduced capability NR devices’ or RedCap. The low complexity UE type is particularly suited for machine type communication (MTC) services such as wireless sensors or video surveillance, but it can also be used for MBB services with lower performance requirements such as wearables. The low complexity UE has reduced capabilities compared to a Release 15 NR UE such as possibility to support lower bandwidth compared to what is currently required for a NR UE and possibility to support only one reception (Rx) branch and one multiple input multiple output (MIMO) layer. The full details thereof can be found from the Release-17 work item description in RP-210918.

The UE performs measurements on one or more downlink (DL) and/or uplink (UL) reference signal (RS) of one or more cells in different UE activity states e.g. radio resource control (RRC) idle state, RRC inactive state, RRC connected state, etc. The measured cell may belong to or operate on the same carrier frequency as of the serving cell (e.g. intra-frequency carrier) or it may belong to or operate on different carrier frequency as of the serving cell (e.g. non-serving carrier frequency). The non-serving carrier may be called as inter-frequency carrier if the serving and measured cells belong to the same radio access technology (RAT) but different carriers. The non-serving carrier may be called as inter-RAT carrier if the serving and measured cells belong to different RATs. Examples of downlink RS include signals in synchronization signal block (SSB), channel state information reference signal (CSI-RS), cell reference signal (CRS), demodulation reference signal (DMRS), primary synchronization signal (PSS), secondary synchronization signal (SSS), signals in synchronization signal/physical broadcast channel (SS/PBCH) block, discovery reference signal (DRS), positioning reference signal (PRS), etc. Examples of uplink RS include signals in sounding reference signal (SRS), DMRS, etc.

Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with respect to reference time (e.g. serving cell's system frame number (SFN)), etc. Therefore, SMTC occasion may also occur with certain periodicity e.g. 5 ms, 10 ms, 20 ms, 40 ms, 80 ms and 160 ms.

Examples of measurements include cell identification (e.g. physical cell identifier (PCI) acquisition, PSS/SSS detection, cell detection, cell search, etc.), reference symbol received power (RSRP), reference symbol received quality (RSRQ), secondary synchronization RSRP (SS-RSRP), SS-RSRQ, signal to interference and noise ratio (SINR), RS-SINR, SS-SINR, CSI-RSRP, CSI-RSRQ, received signal strength indicator (RSSI), acquisition of system information (SI), cell global identity (CGI) acquisition, reference signal time difference (RSTD), UE reception-transmission (RX-TX) time difference measurement, radio link monitoring (RLM), which consists of Out of Synchronization (out of sync) detection and In Synchronization (in-sync) detection, etc.

The UE is typically configured by the network (e.g. via RRC message) with measurement configuration and measurement reporting configuration e.g. measurement gap pattern, carrier frequency information, types of measurements (e.g. RSRP, etc.), higher layer filtering coefficient, time to trigger report, reporting mechanism (e.g. periodic, event triggered reporting, event triggered periodic reporting, etc.), etc.

The measurements are done for various purposes. Some example measurement purposes are: UE mobility (e.g. cell change, cell selection, cell reselection, handover, RRC connection re-establishment, etc.), UE positioning or location determination, self-organizing network (SON), minimization of drive tests (MDT), operation and maintenance (O&M), network planning and optimization, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for control of measurements. In particular, one of the problems to be solved by the disclosure is that the existing solution of power saving for measurements may not be appropriate for relaxed measurements on carriers subject to clear channel assessment (CCA).

According to a first aspect of the disclosure, there is provided a method performed by a terminal device. The method may comprise obtaining information about at least one relaxed measurement criterion (RMC). The method may further comprise determining whether first criteria associated with a first mode of operation (MO) or second criteria associated with a second MO are satisfied, based at least on the obtained information.

Measurements under the first MO may be less stringent than measurements under the second MO. At least one criterion in at least one of the first criteria and the second criteria may be associated with a result of CCA procedure in at least one cell. The method may further comprise using a result of the determination for performing one or more operational tasks.

In this way, the performance related to measurements can be improved in a case where the terminal device is configured with RMC and operating on carrier(s) subject to CCA.

In an embodiment of the disclosure, using the result of the determination for performing one or more operational tasks may comprise performing measurements on one or more cells based on the result of the determination.

In an embodiment of the disclosure, performing measurements on one or more cells based on the result of the determination may comprise: performing measurements on the one or more cells according to the MO associated with the satisfied first or second criteria.

In an embodiment of the disclosure, performing measurements on one or more cells based on the result of the determination may comprise determining whether switching from the first MO to the second MO or from the second MO to the first MO is needed.

Performing measurements on one or more cells based on the result of the determination may further comprise, when determining that the switching is needed, determining whether a transition time for the switching is needed and a target MO to be used during the transition time. Performing measurements on one or more cells based on the result of the determination may further comprise, when the transition time is not needed, performing measurements on the one or more cells according to the switched MO. Performing measurements on one or more cells based on the result of the determination may further comprise, when the transition time is needed, performing measurements on the one or more cells according to the target MO during the transition time.

In an embodiment of the disclosure, a serving carrier for the terminal device may be subject to CCA, and at least one non-serving carrier for the terminal device may be subject to CCA, or not subject to CCA, or there is no non-serving carrier configured for the terminal device.

In an embodiment of the disclosure, a serving carrier for the terminal device may be not subject to CCA, and at least one non-serving carrier for the terminal device may be subject to CCA.

In an embodiment of the disclosure, the information about the at least one RMC may be received from a network node via a signaling message.

In an embodiment of the disclosure, a set of RMCs may be predefined in the terminal device. The information about the at least one RMC may be an identifier of the at least one RMC.

In an embodiment of the disclosure, each of the at least one RMC may be associated with a part or all of carriers configured for the terminal device.

In an embodiment of the disclosure, the first criteria associated with the first MO may comprise: a third criterion related to CCA and a fourth criterion related to RMC. Or the first criteria may comprise the fourth criterion related to RMC and a fifth criterion related to serving carrier not subject to CCA.

In an embodiment of the disclosure, whether the third criterion related to CCA is satisfied may be determined for a serving carrier subject to CCA or at least one non-serving carrier subject to CCA.

In an embodiment of the disclosure, the third criterion related to CCA may be based on a comparison between a number of CCA failures or successes occurring in a cell during a first predetermined time period and a first predetermined threshold for the at least one RMC.

In an embodiment of the disclosure, the second criteria associated with the second MO may comprise at least one of a sixth criterion related to CCA and a seventh criterion related to RMC.

In an embodiment of the disclosure, whether the sixth criterion related to CCA is satisfied may be determined for a serving carrier subject to CCA or at least one non-serving carrier subject to CCA.

In an embodiment of the disclosure, the sixth criterion related to CCA may be based on a comparison between a number of CCA failures or successes occurring in a cell during a second predetermined time period and a second predetermined threshold for the at least one RMC.

In an embodiment of the disclosure, the seventh criterion related to RMC may be opposite to the fourth criterion related to RMC.

In an embodiment of the disclosure, whether the switching from the first MO to the second MO or from the second MO to the first MO is needed may be determined based further on a type of the RMC for which the first or second criteria are satisfied.

In an embodiment of the disclosure, it may be determined that the switching from the first MO to the second MO is needed, when one of following conditions is satisfied: the terminal device is performing measurements according to the first MO and the first criteria are determined to be not satisfied; and the terminal device is performing measurements according to the first MO and the second criteria are determined to be satisfied.

In an embodiment of the disclosure, the second MO or the first MO may be determined as the target MO to be used during the transition time. Or it may be determined that the transition time is not needed.

In an embodiment of the disclosure, it may be determined that the switching from the second MO to the first MO is needed, when one of following conditions is satisfied: the terminal device is performing measurements according to the second MO and the second criteria are determined to be not satisfied; the terminal device is performing measurements according to the second MO and the first criteria are determined to be satisfied; and the terminal device is performing measurements according to the second MO, the serving carrier is not subject to CCA and the fourth criterion related to RMC is satisfied.

In an embodiment of the disclosure, the second MO may be determined as the target MO to be used during the transition time.

In an embodiment of the disclosure, a length of the transition time may be based on a number of CCA failures or successes occurring in a cell during a third predetermined time period.

In an embodiment of the disclosure, an operational task may comprise preventing measurements to be performed on at least one cell under the first MO.

In an embodiment of the disclosure, a measurement time used in measurements under the first MO may be less stringent than a measurement time used in measurements under the second MO.

In an embodiment of the disclosure, the measurement time used in measurements under the first MO and the measurement time used in measurements under the second MO may be related by a function.

In an embodiment of the disclosure, a configuration related to the first criteria and/or the second criteria may be predefined in the terminal device or received from a network node.

In an embodiment of the disclosure, the method may further comprise providing user data and forwarding the user data to a host computer via the transmission to a base station.

According to a second aspect of the disclosure, there is provided a method performed by a network node. The method may comprise transmitting, to a terminal device, information about at least one RMC. The method may further comprise transmitting, to the terminal device, a configuration related to first criteria and/or second criteria to be used by the terminal device. The first criteria may be associated with a first MO of the terminal device. The second criteria may be associated with a second MO of the terminal device. Measurements by the terminal device under the first MO may be less stringent than measurements by the terminal device under the second MO. At least one criterion in at least one of the first criteria and the second criteria may be associated with a result of CCA procedure by the terminal device in at least one cell.

In this way, it is possible to allow the performance related to measurements to be improved in a case where the terminal device is configured with RMC and operating on carrier(s) subject to CCA.

In an embodiment of the disclosure, the first criteria associated with the first MO of the terminal device may comprise a third criterion related to CCA and a fourth criterion related to RMC. Or the first criteria associated with the first MO of the terminal device may comprise the fourth criterion related to RMC and a fifth criterion related to serving carrier not subject to CCA.

In an embodiment of the disclosure, the third criterion related to CCA may be based on a comparison between a number of CCA failures or successes occurring in a cell during a first predetermined time period and a first predetermined threshold for the at least one RMC.

In an embodiment of the disclosure, the second criteria associated with the second MO of the terminal device may comprise at least one of a sixth criterion related to CCA and a seventh criterion related to RMC.

In an embodiment of the disclosure, the sixth criterion related to CCA may be based on a comparison between a number of CCA failures or successes occurring in a cell during a second predetermined time period and a second predetermined threshold for the at least one RMC.

In an embodiment of the disclosure, the seventh criterion related to RMC may be opposite to the fourth criterion related to RMC.

According to a third aspect of the disclosure, there is provided a terminal device. The terminal device may comprise at least one processor and at least one memory. The at least one memory may contain instructions executable by the at least one processor, whereby the terminal device may be operative to obtain information about at least one RMC. The terminal device may be further operative to determine whether first criteria associated with a first MO or second criteria associated with a second MO are satisfied, based at least on the obtained information. Measurements under the first MO may be less stringent than measurements under the second MO. At least one criterion in at least one of the first criteria and the second criteria may be associated with a result of CCA procedure in at least one cell. The terminal device may be further operative to use a result of the determination for performing one or more operational tasks.

In an embodiment of the disclosure, the terminal device may be operative to perform the method according to the above first aspect.

According to a fourth aspect of the disclosure, there is provided a network node.

The network node may comprise at least one processor and at least one memory. The at least one memory may contain instructions executable by the at least one processor, whereby the network node may be operative to transmit, to a terminal device, information about at least one RMC. The network node may be further operative to transmit, to the terminal device, a configuration related to first criteria and/or second criteria to be used by the terminal device. The first criteria may be associated with a first MO of the terminal device. The second criteria may be associated with a second MO of the terminal device.

Measurements by the terminal device under the first MO may be less stringent than measurements by the terminal device under the second MO. At least one criterion in at least one of the first criteria and the second criteria may be associated with a result of CCA procedure by the terminal device in at least one cell.

In an embodiment of the disclosure, the network node may be operative to perform the method according to the above second aspect.

According to a fifth aspect of the disclosure, there is provided a computer program product. The computer program product may comprise instructions which when executed by at least one processor, cause the at least one processor to perform the method according to any of the above first and second aspects.

According to a sixth aspect of the disclosure, there is provided a computer readable storage medium. The computer readable storage medium may store thereon instructions which when executed by at least one processor, cause the at least one processor to perform the method according to any of the above first and second aspects.

According to a seventh aspect of the disclosure, there is provided a terminal device. The terminal device may comprise an obtaining module for obtaining information about at least one RMC. The terminal device may further comprise a determination module for determining whether first criteria associated with a first MO or second criteria associated with a second MO are satisfied, based at least on the obtained information. Measurements under the first MO may be less stringent than measurements under the second MO. At least one criterion in at least one of the first criteria and the second criteria may be associated with a result of CCA procedure in at least one cell. The terminal device may further comprise a performing module for using a result of the determination for performing one or more operational tasks.

According to an eighth aspect of the disclosure, there is provided a network node. The network node may comprise a first transmission module for transmitting, to a terminal device, information about at least one RMC. The network node may further comprise a second transmission module for transmitting, to the terminal device, a configuration related to first criteria and/or second criteria to be used by the terminal device. The first criteria may be associated with a first MO of the terminal device. The second criteria may be associated with a second MO of the terminal device. Measurements by the terminal device under the first MO may be less stringent than measurements by the terminal device under the second MO. At least one criterion in at least one of the first criteria and the second criteria may be associated with a result of CCA procedure by the terminal device in at least one cell.

According to a ninth aspect of the disclosure, there is provided a method implemented in a communication system including a network node and a terminal device. The method may comprise steps of the method according to the above first aspect and steps of the method according to the above second aspect.

According to a tenth aspect of the disclosure, there is provided a communication system including a terminal device according to the above third or seventh aspect and a network node according to the above fourth or eighth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an example of CCA procedure and channel occupancy time (COT);

FIG. 2A is a flowchart illustrating a method performed by a terminal device according to an embodiment of the disclosure;

FIG. 2B is a flowchart illustrating a method performed by a network node according to an embodiment of the disclosure;

FIG. 3 is a flowchart for explaining the method of FIG. 2A;

FIG. 4 is a block diagram showing an apparatus suitable for use in practicing some embodiments of the disclosure;

FIG. 5A is a block diagram showing a terminal device according to an embodiment of the disclosure;

FIG. 5B is a block diagram showing a network node according to an embodiment of the disclosure;

FIG. 6 is diagram illustrating an example of a communication system in accordance with some embodiments;

FIG. 7 is a diagram illustrating a UE in accordance with some embodiments;

FIG. 8 is a diagram illustrating a network node in accordance with some embodiments;

FIG. 9 is a diagram illustrating a host in accordance with some embodiments;

FIG. 10 is a diagram illustrating a virtualization environment in which functions implemented by some embodiments may be virtualized;

FIG. 11 is a diagram illustrating a host communicating via a network node with a UE over a partially wireless connection in accordance with some embodiments;

FIG. 12 is a flowchart illustrating a method implemented in a communication system in accordance with some embodiments;

FIG. 13 is a flowchart illustrating a method implemented in a communication system in accordance with some embodiments;

FIG. 14 is a flowchart illustrating a method implemented in a communication system in accordance with some embodiments; and

FIG. 15 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The relaxed monitoring criteria for a neighbour cell are specified in 3GPP technical specification (TS) 36.304 v16.6.0. In RRC idle and RRC inactive states, the UE can be configured to relax neighbour cell measurements (e.g. for cell reselection) when the UE meets one or more relaxed measurement criteria (RMC). The UE can be configured for applying relaxed measurements via higher layer signaling e.g. in system information block (SIB) such as in SIB2. Examples of criteria are UE in low mobility, UE not-at-cell-edge, stationary, combined criterion (e.g. UE in low mobility AND not-at-cell-edge, stationary AND not-at-cell-edge), etc.

In one example, the relaxed measurement criterion for a UE with low mobility is fulfilled when the UE speed is below a certain threshold. The UE speed can be expressed in terms of distance per unit time (e.g. Y1 km/hour) and/or in Doppler frequency (e.g. Y2 Hertz). In one specific example, the relaxed measurement criterion for a UE with low mobility is fulfilled if the UE is stationary or static or does not move.

In another example, the low mobility criterion is met when the received signal level at the UE with respect to the cell is static or quasi-static over certain time period (Ts). The received signal from a cell (e.g. serving cell) is static or quasi-static if it does not change by more than certain margin over certain time period, e.g., the variance of the measured signal levels is within a certain threshold. Examples of the received signal include signal strength, path loss, RSRP, Layer 1 RSRP (L1-RSRP), L1-SINR, etc. In one specific example, the relaxed measurement criterion for UE with low mobility is fulfilled when the following condition is met for the serving cell of the UE:

$$( {Srxlev}_{Ref} - Srxlev ) < {S}_{SearchDeltaP} ,$$

where:
Srxlev=current Srxlev value of the serving cell (dB);
Srxlev_{Ref}=reference Srxlev value of the serving cell (dB), set as follows:
After selecting or reselecting a new cell, or
If (Srxlev-Srxlev_{Ref})>0, or
If the relaxed measurement criterion has not been met for a duration of T_{SearchDeltaP},
Then the UE set value of SrxlevRef to the current Srxlev value of the serving cell;
Srxlev is further defined as follows:

$$Srxlev = {Q}_{rxlevmeas} - ( {Q}_{rxlevmin} + {Q}_{rxlevminoffset} ) - {P}_{compensation} - {Qoffset}_{temp} ,$$

where Srxlev is the cell selection received (RX) level value (dB), Qᵣₓₗₑᵥₘₑₐₛ is the measured cell RX level value (RSRP), Qᵣₓₗₑᵥₘᵢₙ is the minimum required RX level in the cell (dBm) and it is signalled by the cell, Q_{rxlevminoffset} is the offset to the signalled Qᵣₓₗₑᵥₘᵢₙ and it is signalled by the cell. Q_{offsettemp} is the offset temporarily applied to a cell and it is signalled by the cell.

The relaxed measurement criterion for stationary UE is defined in a way similar to UE with low mobility. But the actual values for the thresholds for stationary UE might be different compared to those used for low mobility criterion. For example, the UE meets stationary criterion if the received signal from a cell (e.g. serving cell) does not change by more than certain margin (Hs) over certain time period (Ts). On the other hand, UE meets low mobility criterion if the received signal with respect to the cell does not change by more than certain margin (Hm) over certain time period (Tm). In one example, Hs |<| Hm and/or Ts >Tm. In another example, |Hs|=|Hm| and/or Ts >Tm. In another example, |Hs|<|Hm| and/or Ts=Tm.

In one example, the relaxed measurement criterion for UE not at cell edge is fulfilled when the received signal level at the UE from a cell (e.g. serving cell) is above a threshold, e.g. signal strength is above signal strength threshold and/or signal quality is above signal quality threshold.

In another example, the relaxed measurement criterion for UE not at cell edge is fulfilled when the following condition is met for the serving cell of the UE:
Srxlev >S_{SearchThresholdP}, and,
Squal >S_{SearchThresholdQ}, if S_{SearchThresholdQ} is configured,

where:
Srxlev=current Srxlev value of the serving cell (dB);
Squal=current Squal value of the serving cell (dB);
Squal is further defined as follows:

$$Squal = {Q}_{qualness} - ( {Q}_{qualmin} + {Q}_{qualminoffset} ) - {Qoffset}_{temp} ,$$

where Squal is the cell selection quality value (dB), Q_{qualmeas} is the measured cell quality level value (RSRQ), Q_{qualmin} is the minimum required quality level in the cell (dB) and it is signalled by the cell, Q_{qualminoffset} is the offset to the signalled Qqualmin and it is signalled by the cell.

With respect to the combination of relaxed measurement criteria, the UE can be configured with multiple versions (e.g. Rel-16 not-at-cell edge, Rel-17 not-at-cell edge) of not-at-cell edge criteria in which case the actual values for thresholds might be different because the purpose would be to identify the UEs located at different ranges with respect to the cell center.

When one or more relaxed measurement criteria are met, then the UE is allowed to relax measurements or perform relaxed measurements. The measurement relaxation is realized by meeting relaxed measurement requirements. For example, the UE is allowed to meet one or more relax measurement requirements for performing a measurement provided that it is configured with lowMobilityEvaluation IE and also meets the low mobility criterion as defined above. In another example, the UE is allowed to meet one or more relax measurement requirements for performing a measurement provided that it is configured with cellEdgeEvaluation IE and also meets the not at cell edge as defined above. In another example, the UE is allowed to meet one or more relax measurement requirements for performing a measurement provided that it is configured with combineRelaxedMeasCondition IE and also meets the low mobility criterion and not at cell edge as defined above. The parameters/IEs lowMobilityEvaluation, cellEdgeEvaluation and combineRelaxedMeasCondition are defined in TS 38.331 v16.6.0.

The UE is allowed to relax one or more of neighbour cell measurements, e.g. intra-frequency measurements, inter-frequency and inter-RAT measurements when the UE meets one or more relaxed measurement criteria.

Examples of requirements include measurement time, measurement accuracy, measurement reporting periodicity, number of cells measured over measurement time, etc. Examples of measurement time include cell identification or cell detection time, evaluation period or measurement period (e.g. L1 measurement period, L1-RSRP measurement period, L1-SINR measurement period, out of synchronization (OOS) evaluation period, in synchronization (IS) evaluation period, beam failure detection (BFD) evaluation period, L1 indication interval, IS indication interval, OOS indication interval, BFD indication interval, etc.), etc. Examples of measurement accuracy include L1-RSRP accuracy (e.g. within +X1 dB with respect to reference L1-RSRP value), L1-SINR accuracy (e.g. within +X2 dB with respect to reference L1-SINR value). For example, the measurement time of a relaxed measurement (RM) is longer than the measurement time of the corresponding normal measurement (NM) (i.e. when measurement is not relaxed). In one example, the measurement time for RM (T_{meas_RM}) is a function of K and T_{meas_NM}. Examples of functions include maximum, sum, product, etc. In one specific example, T_{meas_RM}=K*T_{meas_NM}, where K >1.

In one example, measurement relaxation is realized by extending the measurement time compared to the measurement time when no relaxation is applied. In another example, measurement relaxation is realized by not performing any neighbour cell measurements. In another example, measurement relaxation is realized by not performing any neighbour cell measurements for certain time period, which may be pre-defined or configured by the network node. Examples of measurement time in low RRC activity state (e.g. RRC idle, RRC inactive states, etc.) include cell detection time (Tdetect), measurement period (Tmeasure), evaluation time (Tevaluate), etc. For example, as shown in Table 1 below, when UE is configured with lowMobilityEvaluation and also meets low mobility criterion, then the UE performs intra-frequency neighbour cell measurements (e.g. T_{detect,NR_Intra}, T_{measure,NR I_Intra} and T_{evaluate,NR_Intra}) with relaxation by applying scaling factor K1=3. Otherwise, when no measurement relaxation is applied, then K=1.

TABLE 1
T_{detect, NR}_{_{—}}_{Intra}, T_{measure, NR}_{_{—}}_{Intra} and T_{evaluate, NR}_{_{—}}_{Intra}

| | Scaling Factor | | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|---|
| DRX cycle | (N1) | | (number of | (number of | (number of |
| length [s] | FR1 | FR2^{Note1} | DRX cycles) | DRX cycles) | DRX cycles) |
| 0.32 | 1 | 8 | 11.52 × N1 × M2 × K1 | 1.28 × N1 × M2 × K1 | 5.12 × N1 × M2 × K1 |
| | | | (36 × N1 × M2 × K1) | (4 × N1 × M2 × K1) | (16 × N1 × M2 × K1) |
| 0.64 | | 5 | 17.92 × N1 × K1 | 1.28 × N1 × K1 | 5.12 × N1 × K1 |
| | | | (28 × N1 × K1) | (2 × N1 × K1) | (8 × N1 × K1) |
| 1.28 | | 4 | 32 × N1 × K1 | 1.28 × N1 × K1 | 6.4 × N1 × K1 |
| | | | (25 × N1 × K1) | (1 × N1 × K1) | (5 × N1 × K1) |
| 2.56 | | 3 | 58.88 × N1 × K1 | 2.56 × N1 × K1 | 7.68 × N1 × K1 |
| | | | (23 × N1 × K1) | (1 × N1 × K1) | (3 × N1 × K1) |

^{Note1}:
Applies for UE supporting power class 2&3&4. For UE supporting power class 1, N1 = 8 for all DRX cycle length.
Note 2:
M2 = 1.5 if SMTC periodicity of measured intra-frequency cell >20 ms; otherwise M2 = 1.
Note 3:
K1 = 3 is the measurement relaxation factor applicable for UE fulfilling the lowMobilityEvaluation [2] criterion.

The unlicensed spectrum can be shared between multiple networks. A device/node prior to transmission on a channel on an unlicensed spectrum performs a clear channel assessment (CCA) to assess or determine whether the channel is busy or not. The CCA procedure is also called as listen before talk (LBT). NR operation in unlicensed spectrum is also called as NR-U, NR with CCA, NR with LBT, etc.

A CCA consists of monitoring the channel for a certain specified time and measuring the received energy and/or in some technologies (e.g. Wi-Fi) checking for preamble transmission indicating the beginning of another device's transmission. The device is allowed to transmit signals on the channel provided that the channel is assessed (e.g. based on CCA) to be idle, which may also be called as clear channel, free channel, available channel, unused channel or channel not busy. The channel is assessed to be idle provided that the received energy or power during the sensing time duration is below a certain energy detection threshold; otherwise, the channel is considered to be busy. The example of energy detection level threshold is −72 dBm, which may further depend on the channel bandwidth e.g. −72 dBm and −75 dBm for 20 Megahertz (MHz) and 10 MHz respectively. If the channel is assessed as “busy”, then the device (UE or base station (BS)) is required to defer the transmission.

After sensing the channel to be idle, the device/node is typically allowed to transmit for a certain amount of time, sometimes referred to as the channel occupancy time (COT) or maximum channel occupancy time (MCOT). The maximum allowed length of the COT depends on regulation and type of CCA (e.g. for how long time the medium was sensed e.g. sensing duration) that has been performed. The COT typically ranges between 1 ms and 10 ms.

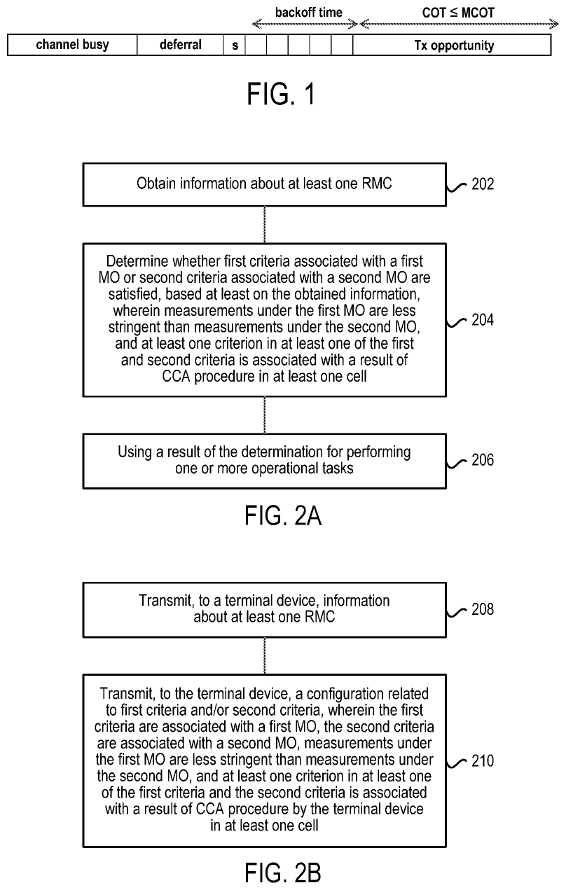

FIG. 1 shows long term evolution (LTE) LBT and COT, where “s” is the sensing time period. In one example, the sensing period can be 25 μs. In this figure, if the channel is determined to be busy, after some deferral time, the device may try again to sense on the channel in order to determine whether the channel is available, and if so, after some backoff time, the device may start transmitting signal (during the device's channel occupancy time) but for no longer than the maximum channel occupancy time (MCOT) which can be e.g. up to 10 ms, depending on the region. The backoff time may be deterministic or statistical.

The UE can be configured with at least one relaxed measurement criterion (RMC) in a set of RMCs (Sr) for enabling UE power saving. In one example,
Sr={RMC1, RMC2, RMC3, RMC4 and RMC5}.

In one example, RMC1 is low mobility criterion, RMC2 is not-at-cell-edge criterion, RMC3 is stationary criterion, RMC4 is low mobility and RMC5 is stationary criterion, etc.

The current relaxed measurement requirements are defined only for operation on carriers of licensed band. In this case, the signals are always transmitted by the BS in resources where the UE measures. The relaxed measurement requirements (for licensed spectrum) are derived by applying a fixed measurement scaling factor (K1) to the legacy measurement requirements (i.e. when no relaxation is applied) when UE meets at least one RMC as described above. The relaxed measurement therefore reduces the measurement opportunities e.g. by factor of 1/K1. In unlicensed operation, radio signals/channel (e.g. SSB) used by the UE for measurements in a cell on carrier subject to CCA (e.g. in NR-U) may not always be transmitted due to DL CCA failure in the cell. This in turn may significantly degrade the mobility performance as it relies on UE measurements.

Therefore, the existing solution of power saving for measurements may not be appropriate for relaxed measurements on carriers subject to CCA (e.g. NR-U carriers). The relaxed measurement procedure and requirements when the UE is operating NR-U carriers and has fulfilled one or more RMCs are currently also undefined. Thus, it would be advantageous to address the new relaxed measurement procedure, UE behavior and relaxed measurement requirements for UE operation in NR-U.

The present disclosure proposes an improved solution for control of measurements. In some scenarios, the UE may be configured to operate (e.g. transmit and/or receive) signals at least on a first cell (cell1) on a first carrier (F1), where operation on F1 is subject to CCA procedure i.e. CCA procedure is applied before transmission of the signals. In some scenarios, the UE may be configured to operate signals on a second cell (cell2) on a second carrier (F2), where CCA procedure is performed before transmission of signals on at least one of F1 and F2. The UE is also configured with at least one relaxed measurement criterion (RMC) in a set of criteria (Sr) and is further evaluating whether or not the RMC is fulfilled.

The improved solution mainly comprises two embodiments. In a first embodiment, a UE configured with at least one RMC, determines whether the UE meets criteria associated with a first mode of operation (MO1) or criteria associated with a second mode of operation (MO2), where at least one criterion in at least one of MO1 and MO2 is associated with results of the CCA procedure (e.g. number of DL CCA failures over time period in cell1 and/or in cell2). The UE further performs measurements according to the determined mode of operation. For example, if criteria for MO1 are met, then the UE is allowed to perform relaxed measurements, or is allowed to start performing relaxed measurements, or is allowed to continue performing relaxed measurements on one or more cells of F1 and/or F2. But if criteria for MO2 are met, then the UE is not allowed to perform relaxed measurements, or is not allowed to continue performing relaxed measurements (if they are ongoing) on one or more cells of F1 and/or F2. In this case, the UE may further be required to perform non-relaxed measurements on one or more cells of F1 and/or F2. The relaxed measurements are performed while meeting requirements associated with the configured RMC. In one example, measurement time (e.g. measurement period) of relaxed measurement is longer than that of the non-relaxed measurement.

In a second embodiment, a UE configured with at least one RMC, determines a measurement mode for performing measurements on one or more cells of F1 and/or F2 during a transition time when switching between MO1 and MO2. The transition may further depend on whether the UE needs to switch from MO1 to MO2 or from MO2 to MO1. For example, if the UE is performing measurement according to MO2 and criteria for MO1 are met, then the UE may continue the measurement according to MO2 during the transition period, and after the transition time the UE may perform measurement according to MO1. In another example, if the UE is performing measurement according to MO1 and criteria for MO2 are met, then the UE may immediately start performing the measurement according to MO2 without any transition period e.g. after MO2 criteria are met.

In the above embodiments, the UE may further use the results of the measurements for one or more operational tasks, e.g. for performing cell change, for transmitting results to a network node, for logging results and transmitting them to the network node at a later time, etc.

The above solution presents clear UE measurement behavior, which is currently missing, when UE is configured with both relaxed measurement criteria and operating on unlicensed carrier i.e. carriers subject to CCA. The solution can further improve UE power saving when operating on unlicensed carrier.

The solution of the present disclosure may be applied to a communication system including a terminal device and a network node (e.g. a base station). The terminal device can communicate through a radio access communication link with the base station. The base station can provide radio access communication links to terminal devices that are within its communication service cell. Note that the communications may be performed between the terminal device and the base station according to any suitable communication standards and protocols.

Examples of network nodes include Node B, base station (BS), multi-standard radio (MSR) radio node such as MSR BS, evolved Node B (eNodeB), next generation Node B (gNodeB), master eNodeB (MeNB), secondary eNodeB (SeNB), location measurement unit (LMU), integrated access backhaul (IAB) node, network controller, radio network controller (RNC), base station controller (BSC), relay, donor node controlling relay, base transceiver station (BTS), central unit (e.g. in a gNB), distributed unit (e.g. in a gNB), baseband unit, centralized baseband, cloud RAN (C-RAN), access point (AP), transmission points, transmission nodes, transmission reception point (TRP), remote radio unit (RRU), remote radio head (RRH), nodes in distributed antenna system (DAS), core network node (e.g. mobile switching center (MSC), mobility management entity (MME), etc.), O&M, operation support system (OSS), self-organization network (SON), positioning node (e.g. evolved serving mobile location center (E-SMLC)), etc.

The terminal device may also be referred to as, for example, device, access terminal, user equipment (UE), mobile station, mobile unit, subscriber station, or the like. The non-limiting term UE (or terminal device) may refer to any type of wireless device communicating with a network node and/or with another UE in a cellular or mobile communication system. Examples of UE include target device, device to device (D2D) UE, vehicular to vehicular (V2V), machine type UE, machine type communication (MTC) UE or UE capable of machine to machine (M2M) communication, personal digital assistant (PDA), tablet, mobile terminals, smart phone, laptop embedded equipment (LEE), laptop mounted equipment (LME), universal serial bus (USB) dongles, etc.

The term radio access technology, or RAT, may refer to any RAT e.g. universal terrestrial radio access (UTRA), evolved-UMTS terrestrial radio access (E-UTRA), narrow band Internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block, discovery reference signal (DRS), CRS, PRS, etc. RS may be periodic e.g. RS occasion carrying one or more RSs may occur with certain periodicity e.g. 20 ms, 40 ms, etc. The RS may also be aperiodic. Each SSB carries NR-PSS, NR-SSS and NR-PBCH in 4 successive symbols. One or multiple SSBs are transmitted in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN), etc. Therefore, SMTC occasion may also occur with certain periodicity e.g. 5 ms, 10 ms, 20 ms, 40 ms, 80 ms and 160 ms. Examples of UL physical signals include reference signal such as SRS, DMRS, etc. The term physical channel may refer to any channel carrying higher layer information e.g. data, control, etc. Examples of physical channels include PBCH, narrow band PBCH (NPBCH), physical downlink control channel (PDCCH), physical downlink shared channel (PDSCH), short physical uplink control channel (sPUCCH), short PDSCH (sPDSCH), sPUCCH, short physical uplink shared channel (sPUSCH), MTC physical downlink control channel (MPDCCH), narrow band PDCCH (NPDCCH), narrow band PDSCH (NPDSCH), enhanced PDCCH (E-PDCCH), PUSCH, PUCCH, narrow band PUSCH (NPUSCH), etc.

The term time resource used herein may correspond to any type of physical resource or radio resource expressed in terms of length of time. Examples of time resources include: symbol, time slot, subframe, radio frame, transmission time interval (TTI), interleaving time, slot, sub-slot, mini-slot, system frame number (SFN) cycle, hyper-SFN (H-SFN) cycle, etc.

The term clear channel assessment (CCA) used herein may correspond to any type of carrier sense multiple access (CSMA) procedure or mechanism which is performed by the device on a carrier before deciding to transmit signals on that carrier. The term carrier may also be interchangeably called as carrier frequency, frequency layer, a channel, a radio channel, a radio frequency channel, etc. The CCA is also interchangeably called CSMA scheme, channel assessment scheme, listen-before-talk (LBT), shared channel access mechanism or scheme, shared spectrum channel access mechanism or scheme, etc. The frequency band of a carrier subject to CCA may also be called as unlicensed band or spectrum, shared spectrum channel access band, band for operation with shared spectrum channel access, etc. The CCA based operation is more generally called contention-based operation. The transmission of signals on a carrier subjected to CCA is also called contention-based transmission. The contention-based operation is typically used for transmission on carriers of unlicensed frequency band. But this mechanism may also be applied for operating on carriers belonging to licensed band for example to reduce interference. The transmission of signals on a carrier which is not subjected to CCA is also called contention free transmission. LBT or CCA procedure can be performed by UE prior to UL transmission and/or by a network node (e.g. base station) prior to DL transmission. Therefore, CCA may also be called as DL CCA (e.g. performed by the BS before DL transmission), UL CCA (e.g. performed by the UE before UL transmission), etc.

The scenario into which the present disclosure is applicable comprises a UE served by a first cell (cell1), which is served or managed by a network node (NW1). Cell1 belongs to or operates on a first carrier frequency (F1). The UE is further configured to perform one or more measurements on at least one neighbor cell, a second cell (cell2), which belongs to or operates on F1. The UE may further be configured to perform one or more measurements on another cell, third cell (cell3), which belongs to or operates on a second carrier frequency (F2). In one example, F1 and F2 may belong to the same RAT e.g. NR. In this case, F1 and F2 may be called as intra-frequency carrier and inter-frequency carrier respectively. In another example, F1 and F2 may belong to different RATs. In this case F2 may be called as inter-RAT carrier e.g. LTE carrier. Inter-frequency carrier and inter-RAT carrier are also called as non-serving carrier-frequency. In one example, operation of signals on cells of both F1 and F2 are subject to CCA. In another example, operation of signals on cells of F1 is subject to CCA; but operation of signals on cells of F2 is not subject to CCA. In another example, operation of signals on cells of F1 is not subject to CCA; but operation of signals on cells of F2 is subject to CCA.

The term “operation of the signal” may refer to any of. transmission of the signal by the device and/or reception of the signal at the device. The term “operation of the signal being subject to CCA” may refer to a scenario in which the device before transmitting a signal in a cell (e.g. cell1, cell2, etc.) of a carrier may apply CCA procedure to decide whether the channel is idle or busy i.e. device transmits signal if the channel is idle, otherwise it defers the transmission. For simplicity, in some embodiments, the term “carrier subject to CCA” may be used, referring to the operation of signal on cells of the carrier when the CCA procedure is applied by the device before transmission of the signal. Each occurrence of the signal or the occurrence when the UE can operate the signal is broadly called as an occasion, which may be transmission occasion or a reception occasion. The occasion is also interchangeably called as signal occasion, signal operational occasion, measurement occasion, signal operational opportunity, signal duration, operational occasion or simply occasion for operating a signal, etc. Examples of occasions include time resources containing RS (e.g. CSI-RS, SSB), SMTC occasion, discovery burst transmission (DBT) window, etc. An occasion may occur once every RS periodicity (e.g. once every SMTC period), once every discontinuous reception (DRX) cycle, every Q^{th} DRX cycle, etc.

The UE may be configured to operate in low activity state. Examples of low activity states include RRC IDLE state, RRC INACTIVE state, etc. In low activity RRC state, the UE may be required to perform measurement once every JP DRX cycle e.g. J=1, J=2, etc. When RMC is met, then the UE measurement activity may be further reduced.

The term carrier may also interchangeably be called as carrier frequency, layer, frequency layer, carrier frequency layer, etc. For consistency, the term carrier is used hereinafter.

In some embodiments, the UE is configured with only F1 which is subject to CCA. In some embodiments, the UE is configured with F1 and F2 provided that at least one them is subject to CCA. The embodiments are applicable for any number of configured carriers provided that at least one carrier is subject to CCA. Examples of scenarios where at least one of the configured carriers is subject to CCA are shown in Table 2 below. The UE is always configured with F1, i.e. serving carrier frequency, which is also called as intra-frequency carrier.

TABLE 2
Examples of scenarios comprising configured
carriers subject to CCA or not

| | Configuration status and CCA applicability | |
|---|---|---|
| | Serving carrier | Non-serving carrier |
| Scenario | frequency (F1) | frequency (F2) |
| 1 | Subject to CCA | Not configured |
| 2 | Subject to CCA | Configured and subject to CCA |
| 3 | Subject to CCA | Configured but not subject to CCA |
| 4 | Not subject to CCA | Configured and subject to CCA |

BS) in a cell. The CCA failure in the cell may be determined by the UE based on one or more of the following principles.

One principle is autonomous determination by the UE. specifically, the UE can determine that CCA has failed in the downlink (e.g. in the base station transmitting the signal) if the UE is unable to receive a signal or if the signal is unavailable at the UE or the UE determines that the signal is not present or it cannot be detected by the UE. For example, the UE may correlate the signal with pre-defined sequences e.g. correlating the SSB expected to be received in certain time-frequency resources with one or more candidate SSBs. If the output or result of the correlation is below certain threshold (T), then the UE assumes that the signal (e.g. SSB) was not transmitted by the base station due to DL CCA failure. Otherwise, if the output or result of the correlation is equal to or above T, then the UE assumes that the signal (e.g. SSB) was transmitted by the base station i.e. DL CCA was successful.

Another principle is explicit indication from the network node. In an example, the network node (e.g. base station) may transmit the results or outcome of the DL CCA failures to the UE. For example, the BS may transmit the outcome or results of the DL CCA in the BS in the last Z1 number of time resources or signals in terms of bitmap to the UE. Each bit may indicate whether the CCA was failure or successful. For example 0 and 1 in bit map may indicate that DL CCA was failure and successful respectively.

The UE is further configured to evaluate at least one relaxed measurement criteria (RMC). The UE can perform relaxed measurement if at least the configured RMC is met. Additional conditions related to CCA procedure to allow or stop relaxed measurements will be described in the later embodiments. The RMC may further belong to a set of RMCs (Sr). The set may comprise one or plurality of RMCs. One example of Sr={RMC1, RMC2, RMC3, RMC4 and RMC5}. In one example, RMC1 is low mobility criterion, RMC2 is not-at-cell-edge criterion, RMC3 is (low mobility AND not-at-cell edge) criterion, RMC4 is stationary criterion and RMC5 is (stationary AND not-at-cell edge) criterion. This is shown in Table 3 below.

TABLE 3
an example of set (Sr) of measurement relaxation criteria (RMCs)

| RMC ID. | Type of RMCs in Sr |
|---|---|
| RMC1 | Low mobility |
| RMC2 | Not-at-cell edge |
| RMC3 | Low mobility AND Not-at-cell edge |
| RMC4 | Stationary |
| RMC5 | Stationary AND Not-at-cell edge |

Hereinafter, two exemplary solutions will be described for ease of understanding the solution of the present disclosure.

### Exemplary Solution #1: Methods in the UE for Performing Relaxed Measurements when Carrier is Subject to CCA

The UE embodiment comprises at least the following: at step 1, the UE obtains information about at least one configured RMC; at step 2, the UE determines whether it meets criteria associated with a first mode of operation (MO1) or criteria associated with a second mode of operation (MO2), where at least one criterion in at least one of MO1 and MO2 is associated with CCA procedure in at least one cell; at step 3, the UE performs measurement on one or more cells according to MO1 or MO2, which meets the criteria. Note that the embodiments described herein may also be implemented in any combination.

Step 1: Obtaining Information about RMC

In this step, the UE obtains information about at least one RMC, which the UE may evaluate. In one example, the UE may obtain information about the RMC based on a message received from the network node e.g. configuration via signaling such as via RRC, downlink control information (DCI) or medium access control (MAC) control element (MAC-CE). For example, a set of RMCs may be pre-defined and the UE may select one or more RMCs from the set of predefined RMCs based on the received identifiers of one or more RMCs from the network node. For example, if the UE is configured with an identifier RMC1, then the UE evaluates the criteria associated with low mobility. The obtained information about the configured RMC(s) may be associated with one or more carriers. In one example, the UE may be configured with RMC(s) which are applicable for all carriers configured for measurements e.g. for mobility measurements. In another example, the UE may be configured with RMC(s) which are applicable for specific set of carriers configured for measurements for certain RAT e.g. for mobility measurements on NR carriers, for mobility measurements on LTE carriers, etc. In another example, the UE may be configured with RMC(s) which are applicable for specific set of carriers configured for measurements e.g. for mobility measurements. In the last two examples, the configured RMC(s) may be linked or associated with information about the carriers e.g. carrier frequency identifier, carrier frequency number, etc. Examples of carrier frequency identifier or number include absolute frequency channel number (ARFCN), NR absolute frequency channel number (NR-ARFCN), etc. Examples of mobility measurements include measurements for cell change e.g. cell selection, cell reselection, RRC connection re-establishment, etc.

### Step 2: Determining Mode of Operation Based on at Least CCA Procedure

In this step, the UE determines whether it meets criteria for performing one or more measurements on one or more cells according to a first mode of operation (MO1) or according to a second mode of operation (MO2).

When criteria for MO1 is met, then the UE performs measurements according to MO1 and in which case the UE is allowed to perform relaxed measurements i.e. the UE can enter into the relaxed measurement mode. Otherwise, the UE is not allowed to enter into the relaxed measurement mode. In the latter case, the UE continues performing the measurements in normal measurement mode (NM) (i.e. non-relaxed measurement mode). The UE may further be configured to enter into the relaxed measurement mode of operation, when the criteria for MO1 is met, for subset of the carriers or for all the carriers, which are configured for the RMC(s). A subset may comprise one or more carriers. The subset of the carriers may be particular type of carriers e.g. carriers subject to CCA, carriers subject to CCA for particular RAT, etc. In another example, the subset of the carriers may be carriers, which are subject to CCA and if at least the criterion #1 (related to CCA procedure) for MO1 is met on at least one cell of that carrier. In another example, the UE may enter into the relaxed measurement mode of operation, when criteria for MO1 is met, for all carriers configured for RMC(s) provided that one or more additional conditions are met. An example of the additional conditions is when serving cell (e.g. cell1) belongs to a carrier, which is subject to CCA.

The UE evaluates criteria for MO2 when the UE is performing relaxed measurements i.e. according to MO1. When criteria for MO2 is met, then the UE is not allowed to perform relaxed measurements or is not allowed to continue performing relaxed measurements anymore i.e. the UE exits the relaxed measurement mode and enters into NM (i.e. non-relaxed measurement mode). Otherwise, the UE is allowed to perform relaxed measurements or is allowed to continue performing relaxed measurements. The UE may further be configured to exit from the relaxed measurement mode of operation, when the criteria for MO2 is met, for subset of the carriers or for all the carriers, which are configured for the RMC(s). A subset may comprise one or more carriers. The subset of the carriers may be particular type of carriers e.g. carriers subject to CCA, carriers subject to CCA for particular RAT, etc. In another example, the subset of the carriers may be carriers, which are subject to CCA and if at least the criterion #1 (related to CCA procedure) for MO2 is met on at least one cell of that carrier. In another example, the UE may exit from the relaxed measurement mode of operation, when criteria for MO2 is met, for all carriers configured for RMC(s) provided that one or more additional conditions are met. An example of the additional conditions is when serving cell (e.g. cell1) belongs to a carrier, which is subject to CCA.

At least one criterion in at least one of the MO1 and MO2 is associated with the result or outcome of the CCA procedure on at least one cell e.g. cell1, cell2 or another cell. The evaluation of the criteria to determine the mode of the operation may further require the UE to evaluate a second criterion related to the obtained RMC.

The results of the CCA procedure can be expressed in terms of CCA failures in a cell. The UE compares results of the CCA procedure in a cell with a threshold over certain time period and determines whether the CCA procedure related criterion is met or not. In one example, CCA results may be expressed in terms of number (N) of CCA failures occurring in a cell during certain time period (T0). In another example, the CCA results may also be or alternatively be expressed in terms of number of successful CCA occurring in a cell during certain time period (T0). A CCA failure during an occasion may also be expressed as unavailability of signal (e.g. reference signal (RS)) at the UE during that occasion. The number of CCA failures may be consecutive or non-consecutive during T0. In one example, N corresponds to number of RS occasions (e.g. SMTC occasions) not transmitted in the cell during T0 due to DL CCA failure. In another example, N corresponds to number of RS occasions (e.g. SMTC occasions) not available at the UE in the cell during T0. In one example, N corresponds to number of DRX cycles each with at least one RS occasion (e.g. SMTC occasion) is not transmitted in the cell due to DL CCA failure during T0. In another example, N corresponds to number of DRX cycles each with at least one RS occasion (e.g. SMTC occasion) not available at the UE during T0. The term RS occasion (e.g. SMTC occasion) not available at the UE may further refer to when the RS occasion (e.g. SMTC) contains RS (e.g. SSBs) configured by the BS in a cell (e.g. cell1) on a carrier frequency (e.g. F1) subject to CCA, but the first two successive candidate RS positions (e.g. SSB positions) for the same RS index (e.g. SS/PBCH block index) within the discovery burst transmission window are not available at the UE due to DL CCA failures at the BS during the corresponding detection, measurement, or evaluation period; otherwise, the RS occasion (e.g. SMTC occasion) is considered as available at the UE.

The two modes of operations will be described below with examples.

### Criteria for First Mode of Operation (MO1)

When criteria for MO1 are met, then the UE selects MO1 and performs one or more radio operations according to MO1. MO1 is selected when either criterion #1 and #2, or criterion #2 and criterion #3 are met:
Criterion #1 for MO1: Criterion related to CCA procedure;
Criterion #2 for MO1: Criterion related to the RMC condition; and
Criterion #3 for MO1: Criterion related to the serving carrier not subject to CCA.

### Criterion #1 Related to CCA Procedure for MO1

Criterion #1 for MO1 will be described with several examples below. In Example 1, the criterion #1 for MO1 is evaluated only for one cell e.g. on cell1 assuming F1 is subject to CCA. This mechanism may be applicable when the serving cell is subject to CCA e.g. it may apply to scenarios #1, #2 and #3 in Table 2.

In one general example in the above scenario (Example #1), the UE determines whether the UE meets criterion #1 for MO1 based on a relation or mapping between parameter, N, and threshold, Hi. The relation is determined or evaluated by the UE during a first time period (T01). In one example, the relation may be a comparison between N and Hi performed during T01. In one specific example in the above scenario, if (N≤Hᵢ) during T01, then the UE meets criterion #1 for MO1; otherwise, the UE does not meet criterion #1 for MO1. N is the number of CCA failures occurring in a cell (e.g. cell1) during T01. Where H; is threshold number of CCA failures during T01 for RMCG. Hi may also be called as the maximum allowed number of CCA failures above which the criterion 1 for MO1 is not met. Hi may be pre-defined or configured by the network node. For example, H1, H2, H3, H4 and H5 are thresholds for RMC1, RMC2, RMC3, RMC4 and RMC5 respectively.

In one example, Hi are different for two or more RMCs. In another example, Hi may be the same for all RMCs. T01 can be pre-defined or configured by the network node. In one example, T01 is a measurement time. Examples of measurement time include cell evaluation period, cell identification period, measurement period, cell reselection time, etc.

In Example 2, criterion #1 for MO1 is evaluated for at least one cell of each carrier which is subject to CCA e.g. on cell2 assuming F2 is subject to CCA. This mechanism may be applicable when serving cell is not subject to CCA e.g. it may apply to scenarios #4 in Table 2.

In one general example in the above scenario (Example #2), the UE determines whether the UE meets criterion #1 for MO1 based on a relation or mapping between parameter, Nj, for carrier Fj and threshold, Hi. The relation is determined or evaluated by the UE during T01. In one example, the relation may be a comparison between Nj and Hi performed during T01. In one specific example in the above scenario, if (Nj≤Hi) during T01, then the UE meets criterion #1 for MO1 for carrier Fj; otherwise, the UE does not meet criterion #1 for MO1 for carrier Fj. Nj is the number of CCA failures occurring in at least one cell (e.g. cell2) on carrier Fj (e.g. F2) during T01. Hi is the same as described in the first example.

### Criterion #2 Related to RMC Condition for MO1

The purpose of criterion #2 related to MO1 is to determine whether the UE is operating in a mobility state or radio conditions or radio environment in which the UE can be allowed to perform relaxed measurements. Criterion #2 is associated with each RMC and may be based on a rule. The rule may be pre-defined or configured by the network node.

For example, if the UE is configured with low mobility criterion (e.g. RMC1), then the UE evaluates whether the low mobility criterion is met or not. In this case, criterion #2 related to RMC condition for MO1 is met provided that the low mobility criterion is met. In one example, low mobility criterion is met provided that the UE speed is below certain threshold (S1) over certain time period (D1); otherwise, low mobility criterion is not met. In another example, low mobility criterion is met provided that the magnitude of the variation of the received signal level measured by the UE in a cell is below certain threshold (S2) over certain time period (D2); otherwise, low mobility criterion is not met. Examples of received signal level include signal strength, signal quality, etc. Examples of signal strength include path loss, RSRP, etc. Examples of signal quality include signal-to-noise ratio (SNR), SINR, RSRQ, etc. The threshold and/or the time period (e.g. S1, S2, D1 and D2) can be pre-defined or configured by the network node.

In another example, the criterion #2 associated with RMC2 (e.g. not-at-cell-edge) is evaluated based on the received signal level measured by the UE in a cell e.g. in cell1. In one example, if the received signal level measured by the UE is above a certain threshold (S3) over certain time period (D3), then the UE is not-at-cell-edge; otherwise, the UE is considered to be at the cell edge. The threshold and/or the time period can be pre-defined or configured by the network node. The threshold and/or the time period (e.g. S3 and D3) can be pre-defined or configured by the network node. Note that different types of conditions to determine whether criterion for the corresponding RMCs is met have been further explained hereinbefore.

### Criterion #3 Related to Serving Carrier for MO1

The purpose of criterion #3 related to MO1 is to determine whether the serving carrier is subject to CCA or not. The UE may be allowed to perform relaxed measurements only if the serving carrier is not subject to CCA and criterion #2 related to the RMC is also met. For example, if the serving carrier is subject to CCA and even if criterion #2 related to the RMC is met, then the UE is not allowed to perform relaxed measurements on one or more cells of one or more configured carriers.

### Criteria for Second Mode of Operation (MO2)

When criteria for MO2 are met, then the UE selects MO2 and performs one or more radio operations according to MO2. MO2 is selected when at least one of the following two criteria is met:
Criterion #1 for MO2: Criterion related to CCA procedure, or
Criterion #2 for MO2: Criterion related to the RMC condition.

### Criterion #1 Related to CCA Procedure for MO2

Criterion #1 for MO2 will be described with several examples below. In Example 1, the criterion #1 for MO2 is evaluated only for one cell e.g. on cell1 assuming F1 is subject to CCA. This mechanism may be applicable when the serving cell is subject to CCA e.g. it may apply to scenarios #1, #2 and #3 in Table 2.

In one general example in the above scenario (Example #1), the UE determines whether the UE meets criterion #1 for MO2 based on a relation or mapping between parameter, N, and threshold, Gi. The relation is determined or evaluated by the UE during a second time period (T02). In one example, the relation may be a comparison between N and Gi performed during T02. In one specific example in the above scenario, if (N>Gᵢ) during T02, then the UE meets criterion #1 for MO2; otherwise, the UE does not meet criterion #1 for MO2. N is the number of CCA failures occurring in a cell (e.g. cell1) during T02. Gᵢ is threshold number of CCA failures during T02 for RMCG. Gi may be pre-defined or configured by the network node. For example, G1, G2, G3, G4 and G5 are thresholds for RMC1, RMC2, RMC3, RMC4 and RMC5 respectively. In one example, Gi are different for two or more RMCs. In another example, Gi may be the same for all RMCs e.g. G=G1=G2=G3=G4=G5. Gi may also be called as the maximum allowed number of CCA failures above which the criterion #1 for MO2 is met. Gi may further depend on one or more parameters. Examples of the parameters include DRX cycle length, extended DRX (eDRX) cycle length, periodicity of a reference signal (T_{RS}) (e.g. SMTC period, DBT window period, etc.). For example, Gi=8 for DRX cycle length (T_{DRX})<1.28 s and Gi=4 for T_{DR}X >1.28 s. T02 can be pre-defined or configured by the network node. In one example, T02 is a measurement time. Examples of measurement time include cell evaluation period, cell identification period, measurement period, cell reselection time, etc.

In Example 2, criterion #1 for MO2 is evaluated for at least one cell of each carrier which is subject to CCA e.g. one cell2 assuming F2 is subject to CCA. This mechanism may be applicable when serving cell is not subject to CCA e.g. it may apply to scenarios #4 in Table 2.

In one general example in the above scenario (Example #2), the UE determines whether the UE meets criterion #1 for MO2 based on a relation or mapping between parameter, Nj, for carrier Fj and threshold, Gi. The relation is determined or evaluated by the UE during T02. In one example, the relation may be a comparison between Nj and Gi performed during T02. In one specific example in the above scenario, if (Nj >Gi) during T02, then the UE meets criterion #1 for MO2 for carrier Fj; otherwise, the UE does not meet criterion #1 for MO2 for carrier Fj. Nj is the number of CCA failures occurring in at least one cell (e.g. cell2) on carrier Fj (e.g. F2) during T02. Gi is the same as described in the first example.

### Criterion #2 Related to RMC Condition for MO2

The purpose of criterion #2 related to MO2 is to determine whether the UE is operating in a mobility state or radio conditions or radio environment in which the UE cannot be allowed to perform relaxed measurements, i.e. when criterion #2 is met then the UE should perform non-relaxed measurements. Criterion #2 is associated with each RMC and may also be based on a rule. The rule may be pre-defined or configured by the network node. Criterion #2 related to RMC condition for MO2 is therefore opposite to or converse of criterion #2 related to the same RMC condition for MO1.

For example, if the UE is configured with low mobility criterion, then the UE evaluates whether the low mobility criterion is met or not. In this case, criterion #2 related to RMC condition for MO2 is met provided that the low mobility criterion is not met. In one example, low mobility criterion is not met provided that the UE speed is equal to or above certain threshold (S1) over certain time period (D1); otherwise, low mobility criterion is met. In another example, low mobility criterion is not met provided that the magnitude of the variation of the received signal level measured by the UE in a cell is equal to or larger than certain threshold (S2) over certain time period (D2); otherwise, low mobility criterion is met.

In another example, the criterion #2 associated with RMC2 (e.g. not-at-cell-edge) is evaluated based on the received signal level measured by the UE in a cell e.g. in cell1. In one example, if the received signal level measured by the UE is equal to or below certain threshold (S3) over certain time period (D3), then the UE is at the cell edge; otherwise, the UE is considered to be not-at-cell-edge. Note that different types of conditions to determine whether criterion for the corresponding RMCs is met have been further explained hereinbefore.

### Step 3: UE Performing Measurements According to the Determined Mode of Operation

The UE after determining or selecting or obtaining the mode of operation (MO1 or MO2) performs one or more measurements on one or more cells of one or more carriers according to the determined mode of the operation. Measurements done according to or based on or associated with MO1 are called as relaxed measurements or less stringent measurements. Measurements done according to or based on or associated with MO2 are called as non-relaxed measurements or more stringent measurements or reference measurements or legacy measurements or normal measurements.

The UE performs the measurement while meeting the associated measurement requirements or more generally requirements. Measurements performed according to MO1 and MO2 are associated with a first set of measurement requirements (RQ1) and a second set of measurement requirements (RQ2) respectively. One or more requirements in RQ1 and RQ2 may be pre-defined or configured by the network node. At least one measurement requirement in set RQ1 and RQ2 are different. Examples of differences are given below.

In one example, at least one requirement (e.g. measurement time) in set RQ1 is less stringent (or more relaxed) than the corresponding requirement (e.g. measurement time) in set RQ2.

In another example, measurement time for at least one measurement in set RQ1 is longer than the corresponding measurement time (for the same type of measurement e.g. cell detection) in set RQ2.

In one specific example, for the same type of the measurement (e.g. cell detection time), the measurement time (Tm1) belonging to or associated with set RQ1 and the measurement time (Tm2) belonging to or associated with RQ2 are related by a function. Tm2 may also be called as reference measurement time or measurement time for measurement when no relaxation is applied. Examples of functions include minimum, maximum, product, average, sum, ratio, xth percentile, floor, ceiling or combination of two or more functions. An example of the general function is given by:

$$Tm 1 = f ( K 1 , Tm 2 ) , \qquad ( 1 )$$

An example of one specific function is given by:

$$Tm 1 = K * Tm 2 , \qquad ( 2 )$$

where K1 is a measurement scaling factor. K1 can be pre-defined or configured by the network node. One example of K1=3. The value of K1 may further depend on the configured RMC.

In another example, when operating in MO1 the UE may not perform any measurement on at least one cell of at least on carrier. This may further depend on the type of the configured RMC. For example, if the UE is configured with RMC3 in Table 3 and the criteria for MO1 is met, then the UE may not perform measurements on one or more cells of one or more carriers. In another example, if the UE is configured with RMC3 in Table 2 and the criteria for MO1 is met, then the UE may only perform measurement on the serving cell and not perform measurements on any other cell of the carriers configured for mobility. Therefore, in this example, performing relaxed measurement comprises not performing the measurement.

Another specific example of the measurement times (T_{detect,NR_Intra_CCA_relax}, T_{measure,NR_Intra_CCA_relax} and T_{evaluate,NR_Intra_CCA_relax}) for relaxed measurements on cells of intra-frequency carrier when MO1 is met is shown in Table 4 below. The corresponding intra-frequency measurement times (T_{detect,NR_Intra_CCA}, T_{measure,NR_Intra_CCA} and T_{evaluate,NR_Intra_CCA}) for relaxed measurements when MO2 is met is shown in Table 5 below i.e. for normal mode of operation. The main difference is that the measurement times in Table 4 scale with K1.

TABLE 4
T_{detect, NR}_{_{—}}_{Intra}_{_{—}}_{CCA}_{_{—}}ᵣₑₗₐₓ, T_{measure, NR}_{_{—}}_{Intra}_{_{—}}_{CCA}_{_{—}}ᵣₑₗₐₓ and T_{evaluate, NR}_{_{—}}_{Intra}_{_{—}}_{CCA}_{_{—}}ᵣₑₗₐₓ
(Requirements in RQ1)

| DRX cycle | T_{detect, NR}_{_{—}}_{Intra}_{_{—}}_{CCA}_{_{—}}relax | T_{measure, NR}_{_{—}}_{Intra}_{_{—}}_{CCA}_{_{—}}relax | T_{evaluate, NR}_{_{—}}_{Intra}_{_{—}}_{CCA}_{_{—}}relax |
|---|---|---|---|
| length [s] | [s] (number of DRX cycles) | [s] (number of DRX cycles) | [s] (number of DRX cycles) |
| 0.32 | 0.32 × (36 + M_{d}) × M2*K1 | 0.32 × (4 + Mₘ) × M2*K1 | 0.32 × (16 + Mₑ) × M2*K1 |
| | {(36 + M_{d}) × M2*K1} | {(4 + Mₘ) × M2*K1 | {(16 + Mₑ) × M2*K1} |
| 0.64 | 0.64 × (28 + M_{d}) *K1 | 0.64 × (2 + Mₘ)*K1 | 0.64 × (8 + Mₑ) |
| | {28 + M_{d}}*K1 | {2 + Mₘ}*K1 | {8 + Mₑ}*K1 |
| 1.28 | 1.28 × (25 + M_{d})*K1 | 1.28 × (1 + Mₘ)*K1 | 1.28 × (5 + Mₑ)*K1 |
| | {25 + M_{d}}*K1 | {1 + Mₘ} | {5 + Mₑ}*K1 |
| 2.56 | 2.56 × (23 + M_{d})*K1 | 2.56 × (1 + Mₘ)*K1 | 2.56 × (3 + Mₑ)*K1 |
| | {23 + M_{d}}*K1 | {1 + Mₘ}*K1 | {3 + Mₑ}*K1 |

Note 1:
M2 = 1.5 if SMTC periodicity of measured intra-frequency cell >20 ms; otherwise M2 = 1.
Note 2:
Md, Mm, Me are the number of DRX cycles each with at least one SMTC occasion not available during the T_{detect, NR}_{_{—}}_{Intra}_{_{—}}_{CCA}, T_{measure, NR}_{_{—}}_{Intra}_{_{—}}_{CCA} and T_{evaluate, NR}_{_{—}}_{Intra}_{_{—}}_{CCA}, and Mₘ ≤ M_{m, max}, M_{d} ≤ M_{d, max} and Mₑ ≤ M_{e, max}
Note 3:
M_{m, max} = 16 for DRX cycle length = 0.32s; M_{m, max} = 8 for DRX cycle length = 0.64s; M_{m, max} = 4 for DRX cycle length = 1.28s; M_{m, max} = 4 for DRX cycle length = 2.56s.
Note 4:
M_{d, max} = 4*M_{m, max}, M_{e, max} = 2*M_{m, max}.
Note 5:
K1 is the measurement relaxation factor applicable for UE fulfilling the certain RMC (e.g. lowMobilityEvaluation criterion)

TABLE 5
T_{detect, NR}_{_{—}}_{Intra}_{_{—}}_{CCA}, T_{measure, NR}_{_{—}}_{Intra}_{_{—}}_{CCA} and T_{evaluate, NR}_{_{—}}_{Intra}_{_{—}}_{CCA}
(Requirements in RQ2)

| DRX cycle | T_{detect, NR}_{_{—}}_{Intra}_{_{—}}_{CCA} | T_{measure, NR}_{_{—}}_{Intra}_{_{—}}_{CCA} | T_{evaluate, NR}_{_{—}}_{Intra}_{_{—}}_{CCA} |
|---|---|---|---|
| length [s] | [s] (number of DRX cycles) | [s] (number of DRX cycles) | [s] (number of DRX cycles) |
| 0.32 | 0.32 × (36 + M_{d}) × M2 | 0.32 × (4 + Mₘ) × M2 | 0.32 × (16 + Mₑ) × M2 |
| | {(36 + M_{d}) × M2} | {(4 + Mₘ) × M2} | {(16 + Mₑ) × M2} |
| 0.64 | 0.64 × (28 + M_{d}) | 0.64 × (2 + Mₘ) | 0.64 × (8 + Mₑ) |
| | {28 + M_{d}} | {2 + Mₘ} | {8 + Mₑ} |
| 1.28 | 1.28 × (25 + M_{d}) | 1.28 × (1 + Mₘ) | 1.28 × (5 + Mₑ) |
| | {25 + M_{d}} | {1 + Mₘ} | {5 + Mₑ} |
| 2.56 | 2.56 × (23 + M_{d}) | 2.56 × (1 + Mₘ) | 2.56 × (3 + Mₑ) |
| | {23 + M_{d}} | {1 + Mₘ} | {3 + Mₑ} |

Note 1:
M2 = 1.5 if SMTC periodicity of measured intra-frequency cell >20 ms; otherwise M2 = 1.
Note 2:
Md, Mm, Me are the number of DRX cycles each with at least one SMTC occasion not available during the T_{detect, NR}_{_{—}}_{Intra}_{_{—}}_{CCA}, T_{measure, NR}_{_{—}}_{Intra}_{_{—}}_{CCA} and T_{evaluate, NR}_{_{—}}_{Intra}_{_{—}}_{CCA}, and Mₘ ≤ M_{m, max}, M_{d} ≤ M_{d, max} and Mₑ ≤ M_{e, max}
Note 3:
M_{m, max} = 16 for DRX cycle length = 0.32s; M_{m, max} = 8 for DRX cycle length = 0.64s; M_{m, max} = 4 for DRX cycle length = 1.28s; M_{m, max} = 4 for DRX cycle length = 2.56s.
Note 4:
M_{d, max} = 4*M_{m, max}, M_{e, max} = 2*M_{m, max}.

Another specific example of the measurement times (T_{detect,NR_Inter_CCA_Relax}, T_{measure,R_Inter_CCA_Relax} and T_{evaluate,NR_Inter_CCA_Relax}) for relaxed measurements on cells of inter-frequency carrier when MOT is met is shown in Table 6 below. The corresponding inter-frequency measurement times (T_{detect,NR_Inter_CCA}, T_{measure,NR_Inter_CCA} and T_{evaluate,NR_Inter_CCA}) for relaxed measurements when MO2 is met is shown in table 7 below i.e. for normal mode of operation. The main difference is that the measurement times in Table 6 scale with KIT by using a max function.

TABLE 6
T_{detect, NR}_{_{—}}_{Inter}_{_{—}}_{CCA}_{_{—}}_{Relax}, T_{measure, NR}_{_{—}}_{Inter}_{_{—}}_{CCA}_{_{—}}_{Relax} and T_{evaluate, NR}_{_{—}}_{Inter}_{_{—}}_{CCA}_{_{—}}_{Relax}
(Requirements in RQ1)

| DRX cycle | T_{detect, NR}_{_{—}}_{Inter}_{_{—}} CCA_{_{—}}_{Relax} | T_{measure, NR}_{_{—}}_{Inter}_{_{—}} CCA_{_{—}}_{Relax} | T_{evaluate, NR}_{_{—}}_{Inter}_{_{—}} CCA_{_{—}}_{Relax} |
|---|---|---|---|
| length [s] | [s] | [s] | [s] |
| 0.32 | Max(0.32 × (36 + M_{d}) × | Max(0.32 × (4 + Mₘ) × | Max(0.32 × (16 + Mₑ) × |
| | M2, 11.52 × M2 × K1) | M2, 1.28 × 1.5 × | M2, 5.12 × M2 × |
| | | K1 (4 × M2 × K1) | K1) |
| 0.64 | Max(0.64 × (28 + M_{d}), | Max(0.64 × (2 + Mₘ), | Max(0.64 × (8 + Mₑ), |
| | 17.92 × K1) | 1.28 × K1) | 5.12 × K1) |
| 1.28 | Max(1.28 × (25 + M_{d}), | Max(1.28 × (1 + Mₘ), | Max(1.28 × (5 + Mₑ), |
| | 32 × K1) | 1.28 × K1) | 6.4 × K1) |
| 2.56 | Max(2.56 × (23 + M_{d}), | Max(2.56 × (1 + Mₘ), | Max (2.56 × (3 + Mₑ), |
| | 58.88 × K1) | 2.56 × K1) | 7.68 × K1) |

Note 1:
M2 = 1.5 if SMTC periodicity of measured intra-frequency cell >20 ms; otherwise M2 = 1.
Note 2:
Md, Mm, Me are the number of DRX cycles each with at least one SMTC occasion not available at the UE during T_{detect, NR}_{_{—}}_{Inter}_{_{—}}_{CCA}, T_{measure, NR}_{_{—}}_{Inter}_{_{—}}_{CCA} and T_{evaluate, NR}_{_{—}}_{Inter}_{_{—}}_{CCA}, and Mₘ ≤ M_{m, max}, M_{d} ≤ M_{d, max} and Mₑ ≤ M_{e, max}
Note 3:
M_{m, max} = 16 for DRX cycle length = 0.32s;
M_{m, max} = 8 for DRX cycle length = 0.64s;
M_{m, max} = 4 for DRX cycle length = 1.28s;
M_{m, max} = 4 for DRX cycle length = 2.56s
Note 4:
M_{d, max} = 4*M_{m, max}, M_{e, max} = 2*M_{m, max}.
Note 5:
K1 is the measurement relaxation factor applicable for UE fulfilling certain RMC e.g. the low mobility criterion.

TABLE 7
T_{detect, NR}_{_{—}}_{Inter}_{_{—}}_{CCA}, T_{measure, NR}_{_{—}}_{Inter}_{_{—}}_{CCA} and T_{evaluate, NR}_{_{—}}_{Inter}_{_{—}}_{CCA}
(Requirements in RQ2)

| DRX cycle | T_{detect, NR}_{_{—}}_{Inter}_{_{—}}_{CCA} | T_{measure, NR}_{_{—}}_{Inter}_{_{—}}_{CCA} | T_{evaluate, NR}_{_{—}}_{Inter}_{_{—}}_{CCA} |
|---|---|---|---|
| length [s] | [s] (number of DRX cycles) | [s] (number of DRX cycles) | [s] (number of DRX cycles) |
| 0.32 | 0.32 × (36 + M_{d}) × M2 | 0.32 × (4 + Mₘ) × M2 | 0.32 × (16 + Mₑ) × M2 |
| | {(36 + M_{d}) × M2} | {(4 + Mₘ) × M2} | {([6 + Mₑ) × M2} |
| 0.64 | 0.64 × (28 + M_{d}) | 0.64 × (2 + Mₘ) | 0.64 × (8 + Mₑ) |
| | {28 + M_{d}} | {2 + Mₘ} | {8 + Mₑ} |
| 1.28 | 1.28 × (25 + M_{d}) | 1.28 × (1 + Mₘ) | 1.28 × (5 + Mₑ) |
| | {25 + M_{d}} | {1 + Mₘ} | {5 + Mₑ} |
| 2.56 | 2.56 × (23 + M_{d}) | 2.56 × (1 + Mₘ) | 2.56 × (3 + Mₑ) |
| | {23 + M_{d}} | {1 + Mₘ} | {3 + Mₑ} |

Note 1:
M2 = 1.5 if SMTC periodicity of measured intra-frequency cell >20 ms; otherwise M2 = 1.
Note 2:
Md, Mm, Me are the number of DRX cycles each with at least one SMTC occasion not available at the UE during T_{detect, NR}_{_{—}}_{Inter}_{_{—}}_{CCA}, T_{measure, NR}_{_{—}}_{Inter}_{_{—}}_{CCA} and T_{evaluate, NR}_{_{—}}_{Inter}_{_{—}}_{CCA}, and Mₘ ≤ M_{m, max}, M_{d} ≤ M_{d, max} and Mₑ ≤ M_{e, max}
Note 3:
M_{m, max} = 16 for DRX cycle length = 0.32s;
M_{m, max} = 8 for DRX cycle length = 0.64s;
M_{m, max} = 4 for DRX cycle length = 1.28s;
M_{m, max} = 4 for DRX cycle length = 2.56s
Note 4:
M_{d, max} = 4*M_{m, max}, M_{e, max} = 2*M_{m, max}.

In another example, it is assumed that the UE is operating in scenario #2 in Table 2 and has fulfilled the MO1 criteria and measures according a more relaxed requirements compared to those of MO2. In this case, the UE switches to MO2 after fulfilling the MO2 criteria on any of the neighbour cells.

In another example, it is assumed that the UE is operating in scenario #2 in Table 2 and has fulfilled the MO1 criteria and measures according a more relaxed requirements compared to those of MO2. In this case, the UE switches to MO2 after fulfilling the MO2 criteria on cells of all configured neighbour carriers e.g. configured for mobility measurements.

In another example, it is assumed that the UE is operating in scenario #2 in Table 2 and has fulfilled the MO1 criteria and measures according a more relaxed requirements compared to those of MO2. In this case, the UE switches to MO2 after fulfilling the MO2 criteria on any of the serving or neighbour cells of all configured carriers.

In another example corresponding to scenario #4 in Table 2 where the serving cell is not subject to CCA while the cells configured on the non-serving carriers are subject to CCA. In this case, UE switches from MO1 to MO2 when MO2 criteria are fulfilled and/or when MO1 criteria are no longer fulfilled on neighbour cells on all configured non-serving carriers.

In another example corresponding to scenario #4 in Table 2 where the serving cell is not subject to CCA while the cells configured on the non-serving carriers are subject to CCA. In this case, UE switches from MO1 to MO2 when MO2 criteria are fulfilled and/or when MO1 criteria are no longer fulfilled on neighbour cells on all of non-serving carriers which are subjective to CCA or on non-serving carriers on which the UE has fulfilled the criterion #1 for MO2.

In another example corresponding to scenario #4 in Table 2 where the serving cell is not subject to CCA while the cells configured on the non-serving carriers are subject to CCA. In this case, the UE may continue operating in the relaxed mode (MO1) on neighbour cells even after fulfilling the MO2 criteria. The reason is that the CCA failures on the non-serving carrier should not affect the serving cell performance as long as the UE has fulfilled the corresponding RMC.

In another aspect of examples above, whether to revert to MO2 upon fulfilling the MO2 criteria on all carriers or subsets of carriers may further depend on type of RMC that is fulfilled. In one specific example, the UE may revert to MO2 as exemplified in above examples for certain types of RMC (e.g. not-at-cell edge, low-mobility) while it may remain operating in relaxed mode after fulfilling MO2 in other types of RMC (e.g. stationary, not-at-cell-edge and low-mobility) where the UE mobility is more limited in the latter case compared to the former case.

### Exemplary Solution #2: UE Performing Measurements During the Transition Period

The second embodiment defines UE measurement procedure, UE behaviour and measurement requirements during transition period occurring after the UE changes or switches from performing measurements using MO1 to MO2, or after the UE changes or switches from performing measurements using MO2 to MO1. The rules for measurements during the transition periods (e.g. which measurement mode to be used or whether transition is needed or not) can be pre-defined or configured by the network node. The rules for measurements during the transition periods will be described below with a few examples.

In one example of the rule, when the UE is performing a measurement in MO2 and if the conditions or criteria for MO1 are met, then the UE may continue the measurement and fulfill the requirements corresponding to MO2 during the transition period T1. After the transition period T1, the UE will perform measurements based on or associated with the requirements (e.g. RQT) in MO1.

In another example of the rule, the UE is performing measurement in MO2 and the condition for MO1 is met due to the number of CCA failures less than certain threshold (Qi) in time period T03. In one example, Qi is less than Hi (defined in Exemplary solution #1). In this case (i.e. if N≤Qi), the UE will continue the measurements according to MO2 after T03. The measurement samples before T03 will be counted in the measurement requirements during the transition period T1. After the transition period, the UE will perform measurements based on the requirements in MO1. In this case, it is assumed that the MO1 requirements are more relaxed than MO2.

In another example of the rule, when the UE is performing a measurement in MO1 and if the conditions or criteria for MO2 are met, then the UE may continue the measurement and fulfill the requirements corresponding to MO1 during the transition period T2. After the transition period T2, the UE will perform measurements based on or associated with the requirements (e.g. RQ2) in MO2.

In another example of the rule, when the UE is performing a measurement in MO1 and if the conditions or criteria for MO2 are met, then the UE is not allowed to have any transition. In this case the UE is required to start performing measurements based on or associated with the requirements (e.g. RQ2) in MO2, after the MO2 criteria are met.

In another example, the transition measurement applies in one direction only (e.g. when transitioning from MO1 to MO2 and not from MO2 to MO1). For example, the UE is performing measurements according to the requirements of MO1 and switches to MO2 requirements immediately when the criteria for MO1 is no longer fulfilled or when the MO2 criteria are fulfilled. In this case, it is assumed that the MO1 requirements are more relaxed than MO2. However, when transitioning from MO2 to MO1, the UE is allowed delay the transition to MO1 if UE has fulfilled the criteria of MO1 for a certain time duration, e.g. T04, where T04 may correspond to a measurement period for the measurement. This means the UE meets the requirements corresponding to MO2 during the transition period T1. The motivation for delaying is that the UE could be performing measurements already based on much stringent requirements compared to MO1 and therefore it is allowed to complete those before entering a more relaxed mode. T1 can be predefined or configured by the network (NW).

In another aspect of the UE embodiment related to measurements during transition period, the length of transition period (T1, T2 in the examples above) depends on number of CCA failures (N) determined during certain time period. In one example, a shorter transition period is assumed when the number of CCA failures is large and a longer transition period can be allowed when the number of CCA failures is fewer. More specifically T1 is less than certain threshold (Tx) if number of CCA failures is above threshold (Ex); otherwise T1>Tx. Similarly T2 is less than certain threshold (Ty) if number of CCA failures is above threshold (Ey); otherwise T2≥Ty. The reason is when switching from MO1 to MO2, the UE should revert to normal mode as early as possible and try to perform measurements more frequently. In another example, the length of transition period can be extended as the number of CCA failures increases because UE is allowed to use more measurement occasions to compensate for the missed measurement attempts due to CCA failures.

In another example, the UE is performing measurement in MO1 and the condition for MO1 is not met due to the number of CCA failures exceeding certain threshold (Bi) in time period T05. In this case, the UE will restart the measurements based the criteria for MO2 after T05. In one example, Bi >Gi (defined in exemplary solution #1). The measurement samples before T05 will be abandoned. After T05, the UE will perform measurements based on the requirements in MO2.

Hereinafter, the solution of the present disclosure will be further described with reference to FIG. 2A to FIG. 15.

FIG. 2A is a flowchart illustrating a method performed by a terminal device according to an embodiment of the disclosure. The method may be applicable to four scenarios. In the first scenario, the serving carrier for the terminal device is subject to CCA, and at least one non-serving carrier for the terminal device is subject to CCA. In the second scenario, the serving carrier for the terminal device is subject to CCA, and at least one non-serving carrier for the terminal device is not subject to CCA. In the third scenario, the serving carrier for the terminal device is subject to CCA, and there is no non-serving carrier configured for the terminal device. In the fourth scenario, the serving carrier for the terminal device is not subject to CCA, and at least one non-serving carrier for the terminal device is subject to CCA.

At block 202, the terminal device obtains information about at least one RMC. For instance, the information about the at least one RMC may be received from a network node via a signaling message. In an exemplary example, a set of RMCs may be predefined in the terminal device. In this case, the information about the at least one RMC may be an identifier of the at least one RMC. In this way, the signaling overhead can be reduced between the network node and the terminal device. Each of the at least one RMC may be associated with a part or all of carriers configured for the terminal device, as described above.

At block 204, the terminal device determines whether first criteria associated with a first mode of operation (MO) or second criteria associated with a second MO are satisfied, based at least on the obtained information. Measurements under the first MO are less stringent than measurements under the second MO. At least one criterion in at least one of the first criteria and the second criteria is associated with a result of CCA procedure in at least one cell.

As an example, the first criteria associated with the first MO may comprise a third criterion related to CCA and a fourth criterion related to RMC. The third criterion related to CCA may be based on a comparison between the number of CCA failures or successes occurring in a cell during a first predetermined time period and a first predetermined threshold for the at least one RMC. In the above first, second and third scenarios, whether the third criterion related to CCA is satisfied may be determined for the serving carrier subject to CCA. In the above first and fourth scenarios, whether the third criterion related to CCA is satisfied may be determined for at least one non-serving carrier subject to CCA. The fourth criterion related to RMC may be related to (e.g. the same as) the at least one RMC obtained at block 202.

As another example, the first criteria associated with the first MO may comprise the fourth criterion related to RMC and a fifth criterion related to serving carrier not subject to CCA. For example, in the above fourth scenario, the fifth criterion is satisfied since the serving carrier is not subject to CCA. In this case, if the fourth criterion related to RMC is satisfied, the first criteria may be determined to be satisfied.

For example, the second criteria associated with the second MO may comprise at least one of a sixth criterion related to CCA and a seventh criterion related to RMC. The sixth criterion related to CCA may be based on a comparison between the number of CCA failures or successes occurring in a cell during a second predetermined time period and a second predetermined threshold for the at least one RMC. In the above first, second and third scenarios, whether the sixth criterion related to CCA is satisfied may be determined for the serving carrier subject to CCA. In the above first and fourth scenarios, whether the sixth criterion related to CCA is satisfied may be determined for at least one non-serving carrier subject to CCA. The seventh criterion related to RMC may be opposite to the fourth criterion related to RMC. Note that the configuration related to the first criteria and/or the second criteria may be predefined in the terminal device or received from a network node.

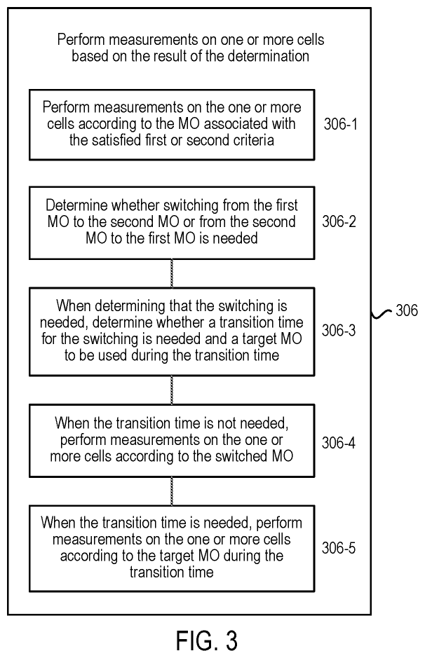

At block 206, the terminal device uses a result of the determination for performing one or more operational tasks. In other words, the terminal device performs one or more operational tasks based on the result of the determination. As an example, block 206 may be implemented as block 306 of FIG. 3. At block 306, the terminal device performs measurements on one or more cells based on the result of the determination. As shown in FIG. 3, block 306 may include block 306-1. At block 306-1, the terminal device performs measurements on the one or more cells according to the MO associated with the satisfied first or second criteria. In this way, since the MO determined by considering the result of CCA procedure is used for performing measurements, the performance related to measurements can be improved for the terminal device. For instance, the measurement time used in the measurements under the first MO may be less stringent than the measurement time used in the measurements under the second MO. For this end, the measurement time used in the measurements under the first MO and the measurement time used in the measurements under the second MO may be related by a function, as described above.

As also shown in FIG. 3, block 306 may also include blocks 306-2 to 306-5. At block 306-2, the terminal device determines whether switching from the first MO to the second MO or from the second MO to the first MO is needed, based on the result of the determination at block 204. For example, the terminal device may determine that the switching from the first MO to the second MO is needed, when one of following conditions is satisfied: the terminal device is performing measurements according to the first MO and the first criteria are determined to be not satisfied; and the terminal device is performing measurements according to the first MO and the second criteria are determined to be satisfied.

For example, the terminal device may determine that the switching from the second MO to the first MO is needed, when one of following conditions is satisfied: the terminal device is performing measurements according to the second MO and the second criteria are determined to be not satisfied; the terminal device is performing measurements according to the second MO and the first criteria are determined to be satisfied; and the terminal device is performing measurements according to the second MO, the serving carrier is not subject to CCA and the fourth criterion related to RMC is satisfied.

Optionally, whether the switching from the first MO to the second MO or from the second MO to the first MO is needed may be determined based further on a type of the RMC for which the first or second criteria are satisfied. For example, as described above, when the result of the determination at block 204 shows that the switching from the first MO to the second MO is needed, the terminal device may switch to the second MO for certain types of RMC (e.g. not-at-cell edge, low-mobility), while the terminal device may remain operating in the first MO in other types of RMC (e.g. stationary, not-at-cell-edge and low-mobility).

When determining that the switching is needed, the terminal device determines whether a transition time for the switching is needed and a target MO to be used during the transition time at block 306-3. For example, as described above, the determination at block 306-3 may be based on a preconfigured rule. For the case that the switching from the first MO to the second MO is needed, the preconfigured rule may specify that the transition time is not needed, or the second MO (or the first MO) is to be used during the transition time. For the case that the switching from the second MO to the first MO is needed, the preconfigured rule may specify that the second MO is to be used during the transition time. As also described above, the length of the transition time may be based on the number of CCA failures or successes occurring in a cell during a third predetermined time period.

When the transition time is not needed, the terminal device performs measurements on the one or more cells according to the switched MO (e.g. the second MO in the case of the switching from the first MO to the second MO) at block 306-4. When the transition time is needed, the terminal device performs measurements on the one or more cells according to the target MO during the transition time at block 306-5. After the transition time, the terminal device may performs measurements on the one or more cells according to the MO associated with the satisfied first or second criteria, as described in block 306-1.

It should be noted that block 206 is not limited to be implemented as block 306. As another example, the operational task performed at block 206 may comprise preventing measurements to be performed (or disabling measurements) on at least one cell according to or under the first MO. With the method of FIG. 2A, since the MO determined by considering the result of CCA procedure is used for performing operational task(s), the performance (e.g. power saving) related to measurements can be improved in a case where the terminal device is configured with RMC and operating on carrier(s) subject to CCA.

FIG. 2B is a flowchart illustrating a method performed by a network node according to an embodiment of the disclosure. At block 208, the network node transmits, to a terminal device, information about at least one RMC. At block 210, the network node transmits, to the terminal device, a configuration related to first criteria and/or second criteria to be used by the terminal device. The first criteria are associated with a first MO of the terminal device. The second criteria are associated with a second MO of the terminal device. Measurements by the terminal device under the first MO are less stringent than measurements by the terminal device under the second MO. At least one criterion in at least one of the first criteria and the second criteria is associated with a result of CCA procedure by the terminal device in at least one cell. The details of the first criteria and the second criteria have been described above and are omitted here for brevity. For example, the configuration related to the first criteria may include, but not limited to, the first predetermined time period and the first predetermined threshold for the at least one RMC. The configuration related to the second criteria may include, but not limited to, the second predetermined time period and the second predetermined threshold for the at least one RMC. With the method of FIG. 2B, it is possible to allow the performance related to measurements to be improved in a case where the terminal device is configured with RMC and operating on carrier(s) subject to CCA.

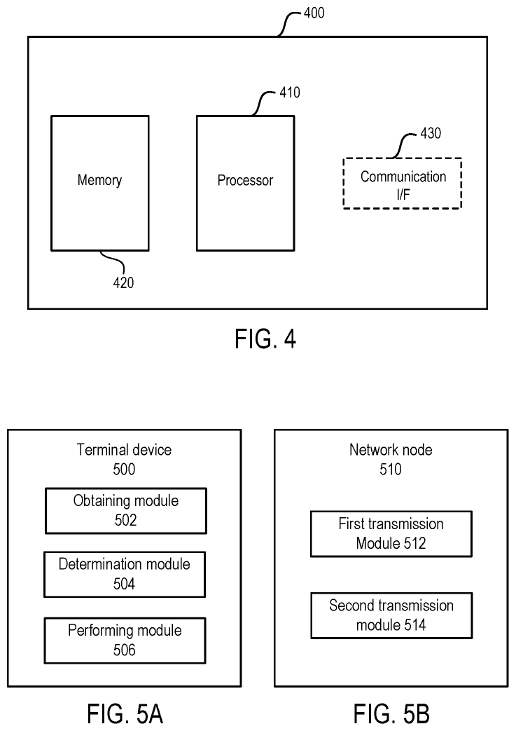

FIG. 4 is a block diagram showing an apparatus suitable for use in practicing some embodiments of the disclosure. For example, any one of the terminal device and the network node described above may be implemented through the apparatus 400. As shown, the apparatus 400 may include a processor 410, a memory 420 that stores a program, and optionally a communication interface 430 for communicating data with other external devices through wired and/or wireless communication.

The program includes program instructions that, when executed by the processor 410, enable the apparatus 400 to operate in accordance with the embodiments of the present disclosure, as discussed above. That is, the embodiments of the present disclosure may be implemented at least in part by computer software executable by the processor 410, or by hardware, or by a combination of software and hardware.

The memory 420 may be of any type suitable to the local technical environment and may be implemented using any suitable data storage technology, such as semiconductor based memory devices, flash memories, magnetic memory devices and systems, optical memory devices and systems, fixed memories and removable memories. The processor 410 may be of any type suitable to the local technical environment, and may include one or more of general purpose computers, special purpose computers, microprocessors, digital signal processors (DSPs) and processors based on multi-core processor architectures, as non-limiting examples.

FIG. 5A is a block diagram showing a terminal device according to an embodiment of the disclosure. As shown, the terminal device 500 comprises an obtaining module 502, a determination module 504 and a performing module 506. The obtaining module 502 may be configured to obtain information about at least one RMC, as described above with respect to block 202. The determination module 504 may be configured to determine whether first criteria associated with a first MO or second criteria associated with a second MO are satisfied, based at least on the obtained information, as described above with respect to block 204. Measurements under the first MO may be less stringent than measurements under the second MO. At least one criterion in at least one of the first criteria and the second criteria may be associated with a result of CCA procedure in at least one cell. The performing module 506 may be configured to use a result of the determination for performing one or more operational tasks, as described above with respect to block 206.

FIG. 5B is a block diagram showing a network node according to an embodiment of the disclosure. As shown, the network node 510 comprises a first transmission module 512 and a second transmission module 514. The first transmission module 512 may be configured to transmit, to a terminal device, information about at least one RMC, as described above with respect to block 208. The second transmission module 514 may be configured to transmit, to the terminal device, a configuration related to first criteria and/or second criteria to be used by the terminal device, as described above with respect to block 210. The first criteria may be associated with a first MO of the terminal device. The second criteria may be associated with a second MO of the terminal device. Measurements by the terminal device under the first MO may be less stringent than measurements by the terminal device under the second MO. At least one criterion in at least one of the first criteria and the second criteria may be associated with a result of CCA procedure by the terminal device in at least one cell. The modules described above may be implemented by hardware, or software, or a combination of both.

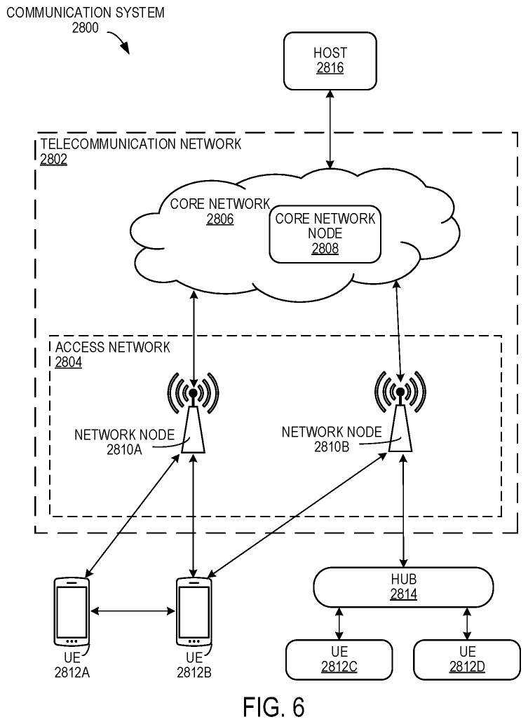

FIG. 6 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

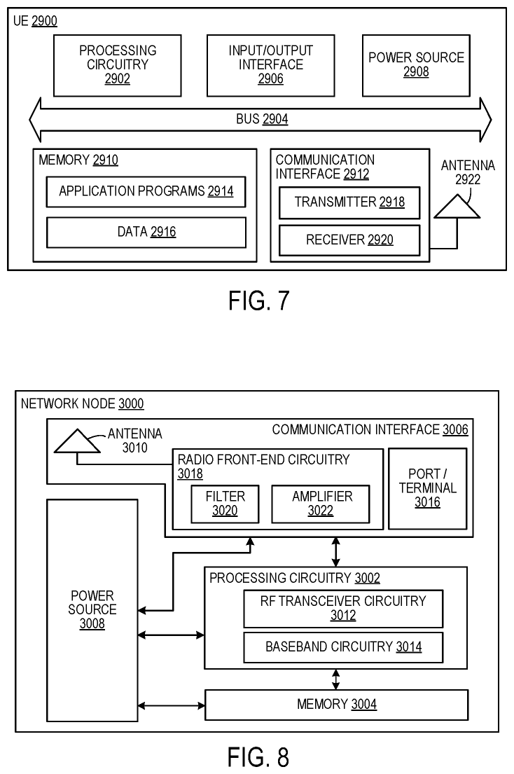

FIG. 7 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal—or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 8 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

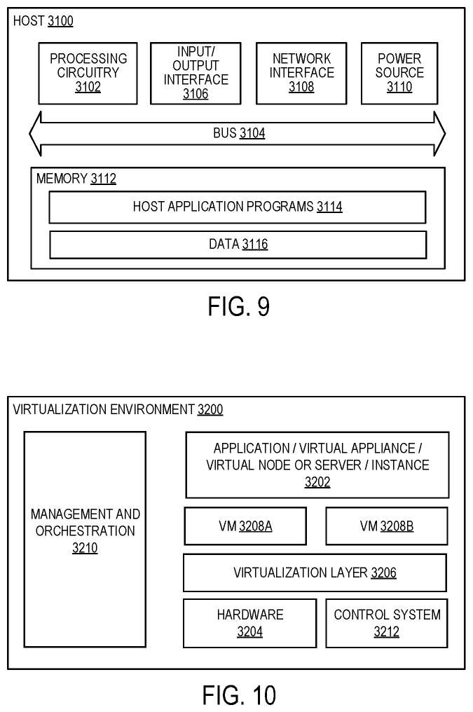

FIG. 9 is a block diagram of a host 3100, which may be an embodiment of the host 2816 of FIG. 6, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 7 and 8, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some methods described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

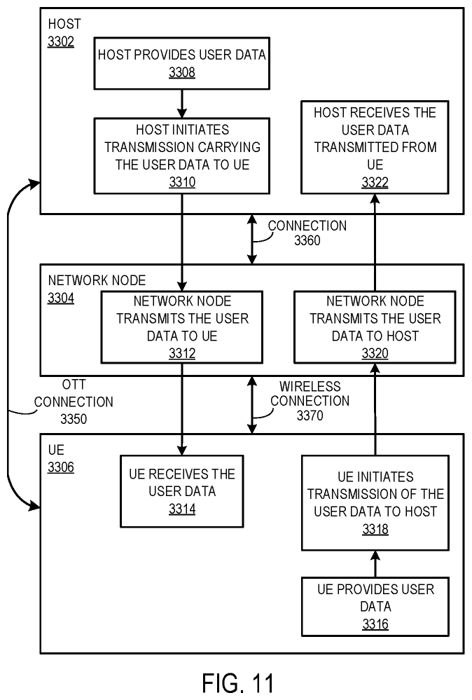

FIG. 11 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 6 and/or UE 2900 of FIG. 7), network node (such as network node 2810a of FIG. 6 and/or network node 3000 of FIG. 8), and host (such as host 2816 of FIG. 6 and/or host 3100 of FIG. 9) discussed in the preceding paragraphs will now be described with reference to FIG. 11.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 6) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302.

In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may improve the power consumption and thereby provide benefits such as extended battery lifetime.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams, etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

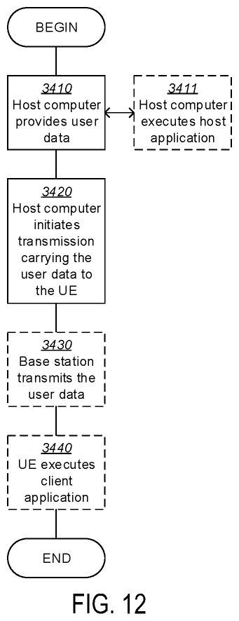

FIG. 12 is a flowchart illustrating a method implemented in a communication system, in accordance with one embodiment. The communication system includes a host computer, a base station and a UE which may be those described with reference to FIGS. 6 and 11. For simplicity of the present disclosure, only drawing references to FIG. 12 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

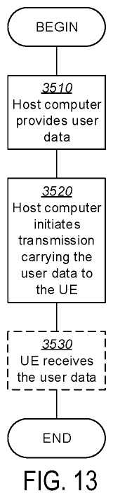

FIG. 13 is a flowchart illustrating a method implemented in a communication system, in accordance with one embodiment. The communication system includes a host computer, a base station and a UE which may be those described with reference to FIGS. 6 and 11. For simplicity of the present disclosure, only drawing references to FIG. 13 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

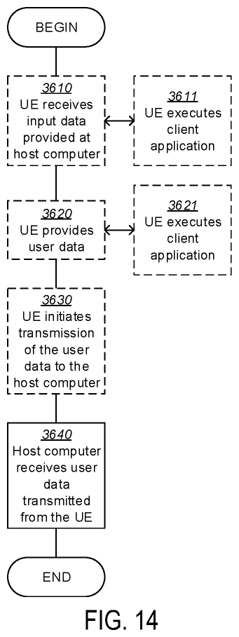

FIG. 14 is a flowchart illustrating a method implemented in a communication system, in accordance with one embodiment. The communication system includes a host computer, a base station and a UE which may be those described with reference to FIGS. 6 and 11. For simplicity of the present disclosure, only drawing references to FIG. 14 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

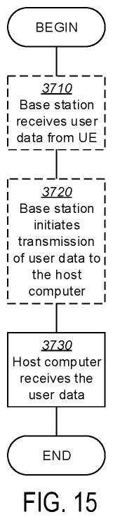

FIG. 15 is a flowchart illustrating a method implemented in a communication system, in accordance with one embodiment. The communication system includes a host computer, a base station and a UE which may be those described with reference to FIGS. 6 and 11. For simplicity of the present disclosure, only drawing references to FIG. 15 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In an aspect of the disclosure, there is provided a method implemented in a communication system including a host computer, a base station and a terminal device. The method comprises, at the host computer, providing user data. The method further comprises, at the host computer, initiating a transmission carrying the user data to the terminal device via a cellular network comprising the base station. The terminal device obtains information about at least one RMC. The terminal device determines whether first criteria associated with a first MO or second criteria associated with a second MO are satisfied, based at least on the obtained information. Measurements under the first MO are less stringent than measurements under the second MO. At least one criterion in at least one of the first criteria and the second criteria is associated with a result of CCA procedure in at least one cell. The terminal device uses a result of the determination for performing one or more operational tasks.

In an embodiment of the disclosure, the method further comprises, at the terminal device, receiving the user data from the base station.

In another aspect of the disclosure, there is provided a communication system including a host computer comprising processing circuitry configured to provide user data and a communication interface configured to forward user data to a cellular network for transmission to a terminal device. The terminal device comprises a radio interface and processing circuitry. The processing circuitry of the terminal device is configured to obtain information about at least one RMC. The processing circuitry of the terminal device is configured to determine whether first criteria associated with a first MO or second criteria associated with a second MO are satisfied, based at least on the obtained information. Measurements under the first MO are less stringent than measurements under the second MO. At least one criterion in at least one of the first criteria and the second criteria is associated with a result of CCA procedure in at least one cell. The processing circuitry of the terminal device is configured to use a result of the determination for performing one or more operational tasks.

In an embodiment of the disclosure, the communication system further includes the terminal device.

In an embodiment of the disclosure, the cellular network further includes the base station configured to communicate with the terminal device.

In an embodiment of the disclosure, the processing circuitry of the host computer is configured to execute a host application, thereby providing the user data. The processing circuitry of the terminal device is configured to execute a client application associated with the host application.

In yet another aspect of the disclosure, there is provided a method implemented in a communication system including a host computer, a base station and a terminal device. The method comprises, at the host computer, receiving user data transmitted to the base station from the terminal device. The terminal device obtains information about at least one RMC. The terminal device determines whether first criteria associated with a first MO or second criteria associated with a second MO are satisfied, based at least on the obtained information. Measurements under the first MO are less stringent than measurements under the second MO. At least one criterion in at least one of the first criteria and the second criteria is associated with a result of CCA procedure in at least one cell. The terminal device uses a result of the determination for performing one or more operational tasks.

In an embodiment of the disclosure, the method further comprises, at the terminal device, providing the user data to the base station.

In an embodiment of the disclosure, the method further comprises, at the terminal device, executing a client application, thereby providing the user data to be transmitted. The method further comprises, at the host computer, executing a host application associated with the client application.

In an embodiment of the disclosure, the method further comprises, at the terminal device, executing a client application. The method further comprises, at the terminal device, receiving input data to the client application. The input data is provided at the host computer by executing a host application associated with the client application. The user data to be transmitted is provided by the client application in response to the input data.

In yet another aspect of the disclosure, there is provided a communication system including a host computer comprising a communication interface configured to receive user data originating from a transmission from a terminal device to a base station. The terminal device comprises a radio interface and processing circuitry. The processing circuitry of the terminal device is configured to obtain information about at least one RMC. The processing circuitry of the terminal device is configured to determine whether first criteria associated with a first MO or second criteria associated with a second MO are satisfied, based at least on the obtained information. Measurements under the first MO are less stringent than measurements under the second MO. At least one criterion in at least one of the first criteria and the second criteria is associated with a result of CCA procedure in at least one cell. The processing circuitry of the terminal device is configured to use a result of the determination for performing one or more operational tasks.

In an embodiment of the disclosure, the communication system further includes the terminal device.

In an embodiment of the disclosure, the communication system further includes the base station. The base station comprises a radio interface configured to communicate with the terminal device and a communication interface configured to forward to the host computer the user data carried by a transmission from the terminal device to the base station.

In an embodiment of the disclosure, the processing circuitry of the host computer is configured to execute a host application. The processing circuitry of the terminal device is configured to execute a client application associated with the host application, thereby providing the user data.

In an embodiment of the disclosure, the processing circuitry of the host computer is configured to execute a host application, thereby providing request data. The processing circuitry of the terminal device is configured to execute a client application associated with the host application, thereby providing the user data in response to the request data.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a terminal device, comprising:
obtaining information about at least one relaxed measurement criterion, RMC;
determining whether first criteria associated with a first mode of operation, MO, or second criteria associated with a second MO are satisfied, based at least on the obtained information, wherein measurements under the first MO are less stringent than measurements under the second MO, and at least one criterion in at least one of the first criteria and the second criteria is associated with a result of clear channel assessment, CCA, procedure in at least one cell; and
using a result of the determination for performing one or more operational tasks.

2. The method according to claim 1, wherein using the result of the determination for performing one or more operational tasks comprises performing measurements on one or more cells based on the result of the determination.

3. The method according to claim 2, wherein performing measurements on one or more cells based on the result of the determination comprises:
performing measurements on the one or more cells according to the MO associated with the satisfied first or second criteria.

4. The method according to claim 2, wherein
performing measurements on one or more cells based on the result of the determination comprises:
determining whether switching from the first MO to the second MO or from the second MO to the first MO is needed;
when determining that the switching is needed, determining whether a transition time for the switching is needed and a target MO to be used during the transition time;
when the transition time is not needed, performing measurements on the one or more cells according to the switched MO; and
when the transition time is needed, performing measurements on the one or more cells according to the target MO during the transition time.

5. The method according to claim 1, wherein a serving carrier for the terminal device is subject to CCA, and at least one non-serving carrier for the terminal device is subject to CCA, or not subject to CCA, or there is no non-serving carrier configured for the terminal device; or
wherein a serving carrier for the terminal device is not subject to CCA, and at least one non-serving carrier for the terminal device is subject to CCA.

6. The method according to claim 1, wherein the information about the at least one RMC is received from a network node via a signaling message.

7. The method according to claim 6, wherein a set of RMCs are predefined in the terminal device; and
wherein the information about the at least one RMC is an identifier of the at least one RMC.

8. The method according to claim 1, wherein each of the at least one RMC is associated with a part or all of carriers configured for the terminal device.

9. The method according to claim 1, wherein the first criteria associated with the first MO comprise:
a third criterion related to CCA and a fourth criterion related to RMC; or
the fourth criterion related to RMC and a fifth criterion related to serving carrier not subject to CCA.

10. The method according to claim 9, wherein whether the third criterion related to CCA is satisfied is determined for a serving carrier subject to CCA or at least one non-serving carrier subject to CCA.

11. (canceled)

12. The method according to claim 1, wherein the second criteria associated with the second MO comprise at least one of a sixth criterion related to CCA and a seventh criterion related to RMC.

13. The method according to claim 12, wherein whether the sixth criterion related to CCA is satisfied is determined for a serving carrier subject to CCA or at least one non-serving carrier subject to CCA.

14-21. (canceled)

22. The method according to claim 1, wherein an operational task comprises preventing measurements to be performed on at least one cell under the first MO.

23. The method according to claim 1, wherein a measurement time used in measurements under the first MO is less stringent than a measurement time used in measurements under the second MO.

24. (canceled)

25. The method according to claim 1, wherein a configuration related to the first criteria and/or the second criteria is predefined in the terminal device or received from a network node.

26. A method performed by a network node, comprising:
transmitting, to a terminal device, information about at least one relaxed measurement criterion, RMC; and
transmitting, to the terminal device, a configuration related to first criteria and/or second criteria to be used by the terminal device, wherein the first criteria are associated with a first mode of operation, MO, of the terminal device, the second criteria are associated with a second MO of the terminal device, measurements by the terminal device under the first MO are less stringent than measurements by the terminal device under the second MO, and at least one criterion in at least one of the first criteria and the second criteria is associated with a result of clear channel assessment, CCA, procedure by the terminal device in at least one cell.

27. The method according to claim 26, wherein the first criteria associated with the first MO of the terminal device comprise:
a third criterion related to CCA and a fourth criterion related to RMC; or
the fourth criterion related to RMC and a fifth criterion related to serving carrier not subject to CCA.

28. (canceled)

29. The method according to claim 26,
wherein the second criteria associated with the second MO of the terminal device comprise at least one of a sixth criterion related to CCA and a seventh criterion related to RMC.

30-31. (canceled)

32. A terminal device comprising:
at least one processor;
at least one memory, the at least one memory containing instructions executable by the at least one processor, whereby the terminal device is operative to:
obtain information about at least one relaxed measurement criterion, RMC;
determine whether first criteria associated with a first mode of operation, MO, or second criteria associated with a second MO are satisfied, based at least on the obtained information, wherein measurements under the first MO are less stringent than measurements under the second MO, and at least one criterion in at least one of the first criteria and the second criteria is associated with a result of clear channel assessment, CCA, procedure in at least one cell; and
use a result of the determination for performing one or more operational tasks.

33. (canceled)

34. A network node comprising:
at least one processor;
at least one memory, the at least one memory containing instructions executable by the at least one processor, whereby the network node is operative to:
transmit, to a terminal device, information about at least one relaxed measurement criterion, RMC; and
transmit, to the terminal device, a configuration related to first criteria and/or second criteria to be used by the terminal device, wherein the first criteria are associated with a first mode of operation, MO, of the terminal device, the second criteria are associated with a second MO of the terminal device, measurements by the terminal device under the first MO are less stringent than measurements by the terminal device under the second MO, and at least one criterion in at least one of the first criteria and the second criteria is associated with a result of clear channel assessment, CCA, procedure by the terminal device in at least one cell.

35-36. (canceled)
